(19) United States
(12) Patent Application Publication
(10) Pub. No.: US 2026/0124841 A1
(43) Pub. Date: May 7, 2026

(54) PRINTING APPARATUS AND CONTROL METHOD

(71) Applicant: CANON KABUSHIKI KAISHA, Tokyo (JP)

(72) Inventor: Hisashi Toyoda, Kanagawa (JP)

(21) Appl. No.: 19/374,221

(22) Filed: Oct. 30, 2025

(30) Foreign Application Priority Data
Nov. 5, 2024 (JP) 2024-193530

(51) Int. Cl. B41J 11/00; B41J 25/00

(52) U.S. Cl. CPC B41J 11/0095; B41J 11/009; B41J 25/001

(57) ABSTRACT

A technology capable of accurately detecting the position of a print medium regardless of the type of print medium is to be provided. A technology that enables downsizing of an apparatus is to be provided. The present disclosure includes: a carriage with a print head mounted thereon that performs printing on a print medium, the carriage being configured to be movable in a width direction of the print medium, which intersects with a conveyance direction of the print medium; a detection unit configured to detect the print medium by causing one or more light-receiving elements of a plurality of light-receiving elements installed on the carriage to function as a light-receiving part; an obtaining unit configured to obtain information on a type of the print medium; and a setting unit configured to set the light-receiving elements to function as the light-receiving part, based on the information obtained by the obtaining unit.

### BACKGROUND

### Field of the Technology

The present disclosure relates to a printing apparatus and a control method.

### Description of the Related Art

Japanese Patent Laid-Open No. 2008-105816 discloses a technology for detecting a position (an end portion) of a print medium by adjusting an amount of light from a light-emitting element in accordance with the type of print medium and a variation in an output value from a component. Further, Japanese Patent Laid-Open No. H09-136741 discloses a technology for detecting an end portion of a print medium by setting a detection threshold, which is obtained by multiplying a difference between an amount of reflected light from a reflection plate (a platen), which serves as a reference, and an amount of reflected light from the print medium by a value greater than 0 but less than 1.

In a case where a reflection-type photoelectric sensor is used as the sensor for detecting the position of a print medium, a detection voltage varies due to differences in reflectivity depending on the types of print media. For example, in a case of a print medium with low reflectivity, a sufficient detection voltage exceeding the detection threshold may not be obtained, and the position of the print medium cannot be detected. In this case, if the amount of light from a light-emitting element is increased by the technology of Japanese Patent Laid-Open No. 2008-105816, a larger current flows through the light-emitting element, resulting in a shortened lifetime of the light-emitting element. Further, if the technology of Japanese Patent Laid-Open No. H09-136741 is applied to change the detection threshold in accordance with the detection voltage, the difference between the detection voltage and the detection threshold may be too small in the case of a print medium with low reflectivity, resulting in a reduced detection margin, which causes susceptibility to influences such as noise.

### SUMMARY

The present disclosure has been made in view of the above-mentioned issues, and provides a technology capable of detecting the position of a print medium with high accuracy regardless of the type of print medium.

A printing apparatus includes: a carriage with a print head mounted thereon that performs printing on a print medium, the carriage being configured to be movable in a width direction of the print medium, which intersects with a conveyance direction of the print medium; a detection unit configured to detect the print medium by causing one or more light-receiving elements of a plurality of light-receiving elements installed on the carriage to function as a light-receiving part; an obtaining unit configured to obtain information on a type of the print medium; and a setting unit configured to set the light-receiving elements to function as the light-receiving part, based on the information obtained by the obtaining unit.

Features of the present disclosure will become apparent from the following description of embodiments with reference to the attached drawings. The following description of embodiments is described by way of example.

### BRIEF DESCRIPTION OF THE DRAWINGS

FIG. 1A and FIG. 1B are schematic configuration diagrams of a printing mechanism.

FIG. 2 is a schematic configuration diagram of sensors;

FIG. 3 is a diagram illustrating an example of the arrangement of light-receiving elements, which form light-receiving parts of a first sensor;

FIG. 4 is a block diagram illustrating a functional configuration of a printing apparatus;

FIG. 5 is a flowchart illustrating a processing routine of print processing;

FIG. 6A and FIG. 6B are diagrams describing determination of the type of print medium using a second sensor;

FIG. 7A to FIG. 7D are diagrams illustrating two light-receiving parts of the first sensor at the time of detecting both ends of the print medium in the width direction;

FIG. 8 is a diagram illustrating the two light-receiving parts of the first sensor at the time of detecting the leading end and trailing end of the print medium;

FIG. 9 is a diagram illustrating a detection circuit connected to the first sensor;

FIG. 10A to FIG. 10C are diagrams describing output waveforms illustrating a change in differential signal at the time of detecting the leading end;

FIG. 11A to FIG. 11E are diagrams illustrating the positional relationship between the two light-receiving parts and the print medium at the time of detecting the leading end;

FIG. 12 is a diagram illustrating output waveforms of differential signals depending on the types of print medium at the time of detecting the leading end;

FIG. 13A to FIG. 13C are diagrams describing output waveforms illustrating a change in differential signal at the time of detecting the trailing end;

FIG. 14A to FIG. 14E are diagrams illustrating the positional relationship between the two light-receiving parts and the print medium at the time of detecting the trailing end;

FIG. 15A to FIG. 15D are diagrams describing output waveforms illustrating changes in differential signal at the time of detecting one end portion;

FIG. 16A to FIG. 16D are diagrams illustrating the positional relationship between the two light-receiving parts and the print medium at the time of detecting one end portion;

FIG. 17A to FIG. 17D are diagrams describing output waveforms illustrating changes in the differential signal at the time of detecting the other end portion;

FIG. 18A to FIG. 18D are diagrams illustrating the positional relationship between the two light-receiving parts and the print medium at the time of detecting the other end portion;

FIG. 19 is a diagram illustrating an example of position detection patches;

FIG. 20A to FIG. 20C are diagrams describing output waveforms illustrating a change in differential signal at the time of detecting the position detection patches;

FIG. 21 is a diagram describing the change in size of a spot area depending on the thickness of the print medium;

FIG. 22A to FIG. 22D are diagrams illustrating two light-receiving parts of the first sensor at the time of detecting both ends of cardboard in the width direction; and

FIG. 23 is a flowchart illustrating a processing routine of print processing according to another embodiment.

### DESCRIPTION OF THE EMBODIMENTS

Hereinafter, with reference to the accompanying drawings, detailed descriptions are given of examples of an embodiment of a printing apparatus and a control method. Note that the following embodiments are not intended to limit the present disclosure, and all combinations of the characteristics described in the present embodiments are not necessarily essential to the solution provided in the present disclosure. Further, the positions, shapes, etc., of the constituent elements described in the embodiments are merely examples and are not intended to limit the scope of this disclosure thereto.

### (First Embodiment)

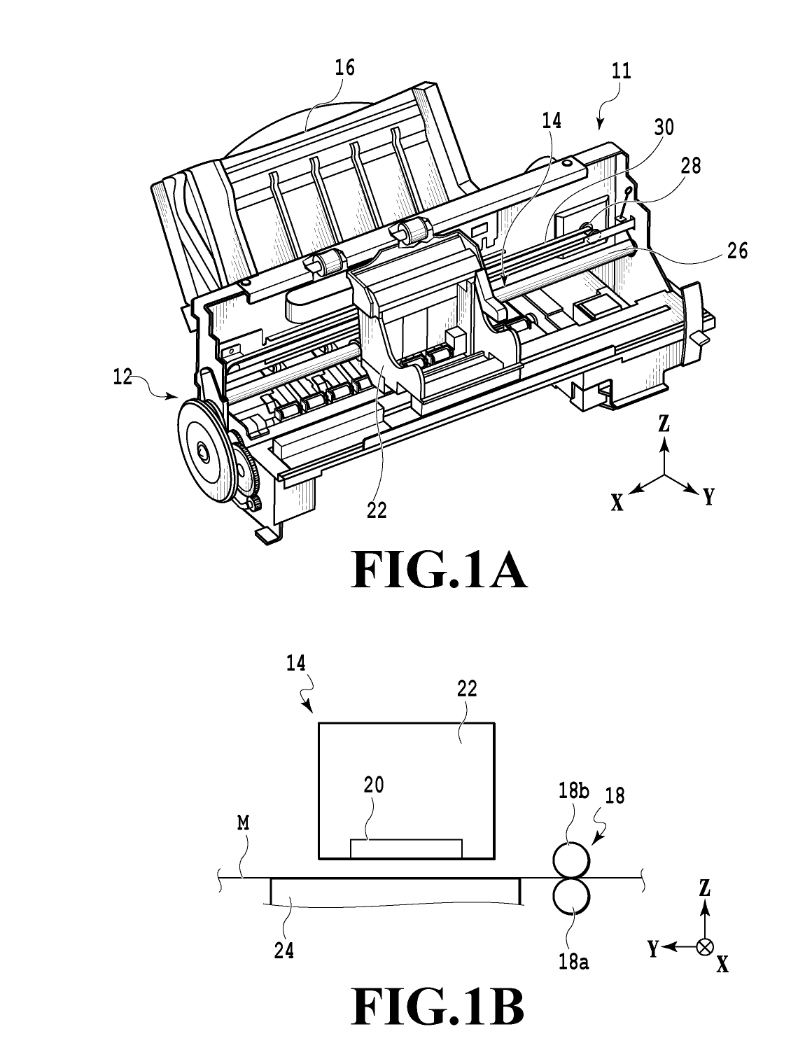

First, with reference to FIG. 1A to FIG. 20C, a detailed description is given about the printing apparatus according to the first embodiment. In the present embodiment, a multi-function printer that has a reading function, a FAX function, and the like in addition to a printing function is described as an example of the printing apparatus. Note that, as for apparatuses to which the technology of the present disclosure can be applied, it is possible to use any apparatus that has a printing function capable of executing printing on a print medium. Note that the description of the configuration of the printing apparatus mainly focuses on the configuration of a printing mechanism that performs printing on a print medium.

### Configuration of the Printing Apparatus

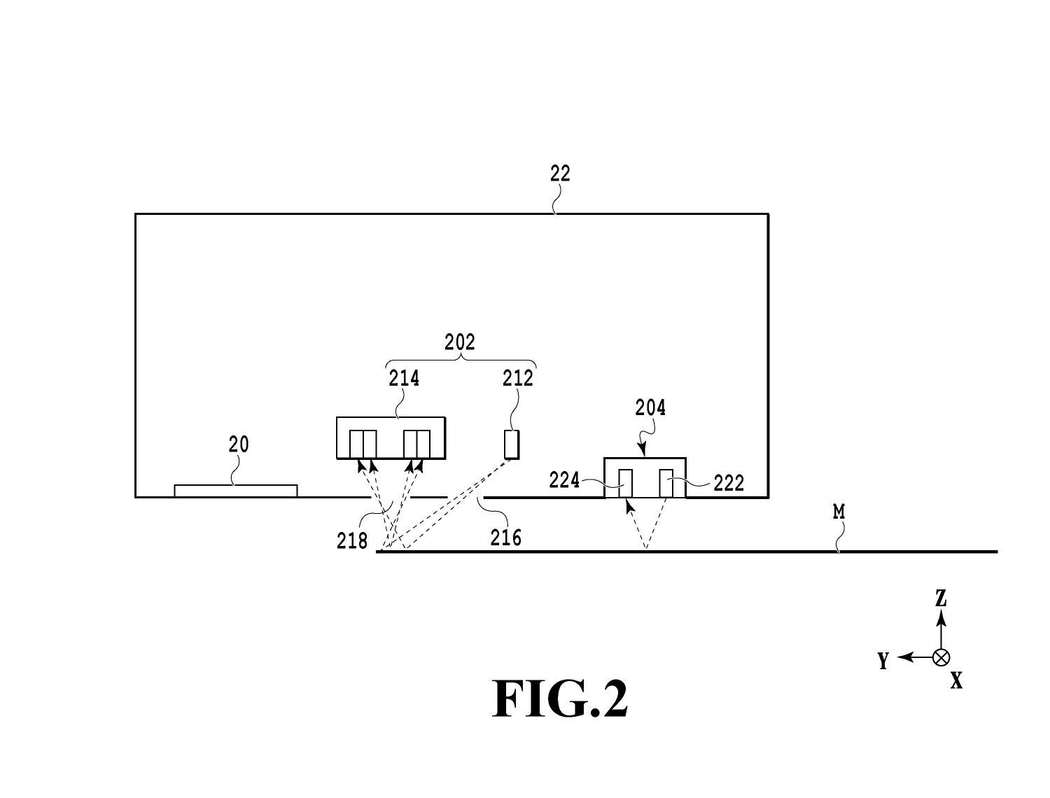

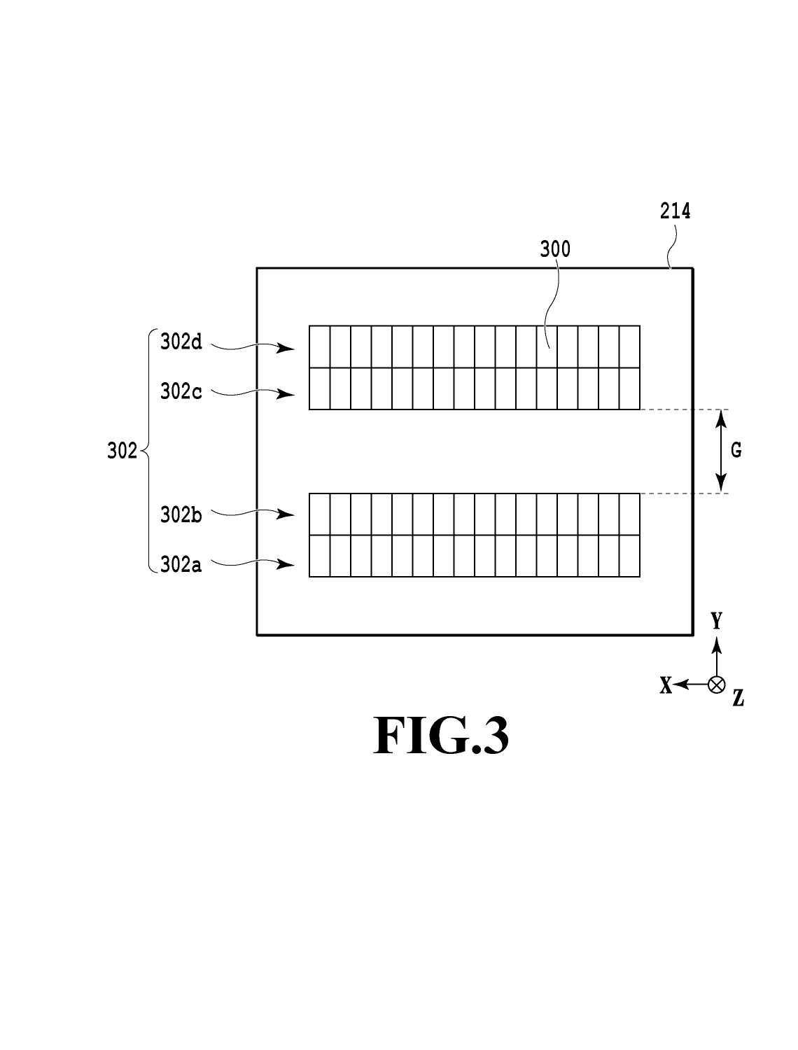

FIG. 1A and FIG. 1B are schematic configuration diagrams of a printing mechanism in the printing apparatus, where FIG. 1A is a perspective view of the printing mechanism and FIG. 1B is a schematic configuration diagram of a printing part in the printing mechanism. FIG. 2 is a schematic configuration diagram of sensors installed in a carriage. FIG. 3 is a diagram illustrating an example of the arrangement of light-receiving elements, which form light-receiving parts of the first sensor. In the present specification, viewing from a position facing the side to which print media are discharged after printing, the direction from the right side toward the left side of the printing apparatus is described as the X direction, the direction from the rear side (the back side) toward the near side (the front side) of the printing apparatus is described as the Y direction, and the direction from the lower side toward the upper side of the printing apparatus is described as the Z direction. In this way, the X direction, Y direction, and Z direction are each a direction from one side toward the other side, and are orthogonal to one another. In the present specification, each direction is represented with a "+ (plus)" in a case where movement is from the one side toward the other side, and with a "− (minus)" in a case where movement is from the other side toward the one side, as appropriate.

As the printing mechanism 11, the printing apparatus 10 includes the conveyance part 12 that conveys the print medium M, and the printing part 14 that performs printing by ejecting ink onto the print medium M conveyed by the conveyance part 12 (see FIG. 1A).

The conveyance part 12 includes the tray 16 on which the print medium M is placed, a cassette (not illustrated in the drawings) that accommodates the print medium M, and the conveyance roller 18 (see FIG. 1B) that conveys the print medium M, which is fed from the tray 16 and the cassette, in the Y direction. The conveyance roller 18 includes the driving roller 18a that is driven by a conveyance motor (not illustrated in the drawings) to rotate, and the driven roller 18b that is in a pressure contact with the driving roller 18a and rotates in association with the driving roller 18a. The print medium M fed from the tray 16 and the cassette is nipped between the driving roller 18a and the driven roller 18b, and is conveyed in the Y direction by the driving of the driving roller 18a.

The printing part 14 includes the print head 20 that ejects ink, and the carriage 22 that is installed so as to be movable in the X direction with the print head 20 mounted thereon. The carriage 22 is installed so as to be slidable on the guide rail 26 extending in the X direction, and is configured to be movable from one side to the other side in the X direction (+X direction) and from the other side to one side (−X direction) via the belt 30 by the driving of the carriage motor 28. Therefore, in the printing part 14, the print head 20 mounted on the carriage 22 can also reciprocally move in the X direction via the carriage 22.

The printing part 14 includes the platen 24 that supports the print medium M conveyed by the conveyance part 12 at a position facing the print head 20 that moves via the carriage 22. In the printing part 14, the print head 20 is configured to eject ink to the print medium M, which is conveyed in the +Y direction (the conveyance direction) and supported by the platen 24, while the print head 20 moves in the width direction (±X direction) of the print medium M via the carriage 22. In the present embodiment, the platen 24 has a characteristic of absorbing irradiated light and reflecting none or hardly any of the light. Note that the print head 20 has nozzle arrays formed by a plurality of nozzles for ejecting ink that are arranged side by side on the surface facing the platen 24. These nozzle arrays extend in the Y direction, which intersects (orthogonally in the present embodiment) with the movement direction (the X direction) of the print head 20.

The printing mechanism 11 performs a printing operation based on print data, in which, while the print head 20 moves (scans) in the X direction, ink is ejected for printing onto the print medium M conveyed by the conveyance part 12 to the printing start position. Next, the conveyance part 12 performs a conveyance operation to convey the print medium M only by a predetermined amount, and then the printing operation is performed again. In this way, in the printing mechanism 11, the printing operation and the conveyance operation are alternately and repeatedly executed, thereby executing printing on the print medium M based on print data.

In the printing mechanism 11, the first sensor 202 and the second sensor 204 capable of detecting the print medium M are installed on the carriage 22 (see FIG. 2). The first sensor 202 is located on the carriage 22, on the upstream side relative to the print head 20 in the +Y direction (the conveyance direction), and the second sensor 204 is located on the carriage 22, on the upstream side relative to the first sensor 202 in the +Y direction.

The first sensor 202 includes the light-emitting member 212 capable of irradiating light onto the print medium M supported by the platen 24, and the light-receiving member 214 capable of receiving reflected light from the print medium M of the light irradiated by the light-emitting member 212. In the present embodiment, the light-emitting member 212 is located on the upstream side relative to the light-receiving member 214 in the +Y direction; however, there is no such limitation. The light emitted from the light-emitting member 212 passes through the opening part (the aperture) 216 formed in the carriage 22 and is irradiated onto the platen 24 and the print medium M supported by the platen 24. Further, the reflected light from the print medium M is received by the light-receiving member 214 via the opening part 218.

The light-receiving member 214 includes the plurality of light-receiving elements 300 so as to be able to receive reflected light incident through the opening part 218 (see FIG. 3). Specifically, the light-receiving member 214 has the plurality of photodiode arrays (PD arrays) 302 arranged in parallel along the Y direction, each of which has a plurality of the light-receiving elements 300 arranged along the X direction. In the present embodiment, the four PD arrays 302, each of which is formed by 16 light-receiving elements 300, are arranged in parallel along the Y direction. More specifically, in the +Y direction, the PD array 302a, the PD array 302b, the PD array 302c, and the PD array 302d are arranged in this order. Furthermore, the PD array 302a and the PD array 302b are adjacent to each other with no interval therebetween, and the PD array 302c and the PD array 302d are adjacent to each other with no interval therebetween. Further, the interval G is formed between the PD array 302b and the PD array 302c.

Note that the arrangement of the light-receiving elements 300 installed on the light-receiving member 214 is not limited to that illustrated in FIG. 3. For example, it is also possible that the group of PD arrays 302 installed on one side of the interval G in the Y direction is formed by three or more PD arrays 302. Further, it is also possible that the group of PD arrays 302 installed on the other side of the interval G in the Y direction is formed by three or more PD arrays 302. Furthermore, the number of light-receiving elements 300 forming one PD array 302 may be more than 16 or less than 16. Moreover, the number of PD arrays 302 installed on the light-receiving member 214 may be five or more, or may be two or three. Alternatively, the multiple PD arrays 302 may be arranged side by side with no interval G in the Y direction. In this case, for example, a plurality of light-receiving elements 300 may be arranged in a matrix in the X and Y directions. Further, although adjacent light-receiving elements 300 are arranged with no interval in the PD arrays 302, they may be arranged in a separated manner with a fixed interval.

The second sensor 204 includes the light-emitting member 222 capable of irradiating light onto the print medium M supported by the platen 24, and the light-receiving member 224 capable of receiving reflected light from the print medium M of the light irradiated by the light-emitting member 222 (see FIG. 2). In the present embodiment, the light-emitting member 222 is located on the upstream side relative to the light-receiving member 224 in the +Y direction; however, there is no such limitation. The second sensor 204 is what is termed as a reflective photosensor, which is a photoelectric conversion member incorporating the light-emitting member 222 and the light-receiving member 224, and is arranged such that the light-emitting surface of the light-emitting member 222 and the light-receiving surface of the light-receiving member 224 face the print medium M supported by the platen 24.

### <Functional Configuration of the Printing Apparatus>

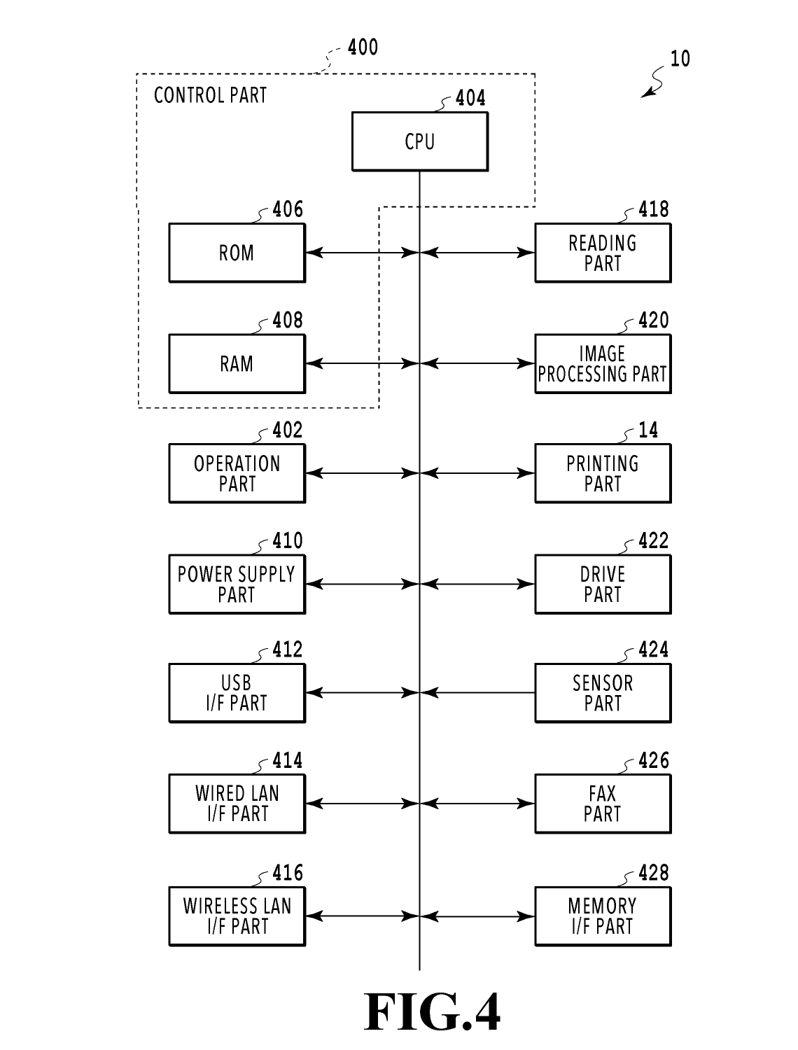

Next, a description is given of the functional configuration of the printing apparatus 10. FIG. 4 is a block diagram illustrating the functional configuration of the printing apparatus 10.

The printing apparatus 10 includes the control part 400 that controls the entire printing apparatus 10, and the operation part 402 that displays various kinds of information related to the printing apparatus 10 and accepts input from the user.

The control part 400 includes the central processing unit (CPU) 404, the ROM 406, and the RAM 408. The CPU 404 loads various control programs stored in the ROM 406 into the RAM 408 and controls each of the later-described configurations of the printing apparatus 10. The RAM 408 is a readable and writable memory configured by a DRAM and has an area for loading control programs as well as an area for temporarily storing various kinds of data. For example, the RAM 408 stores image data read by the reading part 418 (described later) and obtained via the image processing part 420 (described later), as well as print data to be used for printing in the printing part 14. Further, the RAM 408 can store binarized facsimile data that is sent and received via a subscriber line by the facsimile (FAX) part 426 (described later).

The operation part 402 includes operation buttons (not illustrated in the drawings) such as a power key, an operation start key, an operation stop key, and a home position key, and a display part (not illustrated in the drawings) equipped with a touch sensor. The operation part 402 is a user interface for performing various operations and settings of the printing apparatus 10.

The printing apparatus 10 includes the power supply part 410, which is controlled by the CPU 404. The power supply part 410 includes, for example, a switching power supply that outputs DC +24V/+32V voltages from a commercial AC voltage. Further, the power supply part 410 includes a DC/DC converter that outputs DC +1.0V/+1.5V/+3.3V/+5.0V for use in a logic part, from the DC +32V output of the switching power supply.

The printing apparatus 10 includes the USB interface (I/F) part 412, which is controlled by the CPU 404. The USB I/F part 412 is connected to a host computer (Host PC) (not illustrated in the drawings) via a USB cable. It transfers print data from the host PC, scanned data read by the reading part 418, and read/write data to a memory connected to the memory I/F part 428 (described later).

The printing apparatus 10 includes the wired LAN I/F part 414, which is controlled by the CPU 404. The wired LAN I/F part 414 is, for example, a LAN I/F equipped with an RJ-45 connector and compliant with 10Base-T/100Base-TX, and sends and receives data to and from a host PC connected to a network via a switching hub.

The printing apparatus 10 includes the wireless LAN I/F part 416, which is controlled by the CPU 404. The wireless LAN I/F part 416 is, for example, a wireless LAN I/F compliant with IEEE802.11n/11g/11b, and sends and receives data to and from a host PC connected to a network via a wireless LAN router. Further, it is also possible to directly connect to mobile devices such as smartphones and tablets to send and receive data without a wireless LAN router.

The printing apparatus 10 includes the reading part 418, which is controlled by the CPU 404. The reading part 418 includes a photoelectric conversion part such as a contact image sensor (CIS) or a CCD, and sequentially sends image data of original documents read via the CIS or CCD under the control of the CPU 404 to the image processing part 420.

The printing apparatus 10 includes the image processing part 420, which is controlled by the CPU 404. The image processing part 420 includes a clock supply circuit for controlling the reading part 418, a peak hold circuit, a shading correction circuit, an A/D conversion circuit, a DMA controller, etc. The image processing part 420 converts image data read by the reading part 418 into digital data, performs image processing, and transfers the data obtained by the image processing to the RAM 408.

The printing apparatus 10 includes the printing part 14, which is controlled by the CPU 404. The printing part 14 includes a DMA controller, a head control logic circuit, the print head 20, an ink cartridge, etc. Under the control of the CPU 404, the printing part 14 can retrieve print data stored in the RAM 408 and print it out as a hard copy.

The printing apparatus 10 includes the drive part 422, which is controlled by the CPU 404. The drive part 422 includes various motors for driving the driving mechanisms of various members in the printing apparatus 10. Specifically, the drive part 422 includes a scanner motor for automatically reading an original document placed on the platen glass of the reading part 418, an automatic document feeder (ADF) motor for automatically conveying multiple original documents, and a conveyance motor for driving the driving roller 18a (see FIG. 1B). Further, the drive part 422 includes a feeding motor that drives a feeding mechanism for feeding the print medium M from the tray 16 and the cassette, and a discharge motor that drives a discharging mechanism for discharging the print medium M after printing. In addition, the drive part 422 includes the carriage motor 28 (see FIG. 1A) for moving the carriage 22, etc. Furthermore, the drive part 422 includes a recovery motor that drives a cleaning mechanism that cleans the print head 20 and an ink supply part (not illustrated in the drawings) that supplies ink to the print head 20. Further, the drive part 422 includes belts and gears for transmitting driving force to the motors installed in the printing apparatus 10, including the various motors described above, as well as driver circuits for driving the motors, etc.

The printing apparatus 10 includes the sensor part 424, which is controlled by the CPU 404. The sensor part 424 includes various detection parts for detecting the positions of various members in the printing apparatus 10, the position of the print medium M being conveyed, the driving amounts of motors, and the like. Specifically, the sensor part 424 includes a sensor that detects the presence or absence of an original document on the platen glass or the like of the reading part 418, and a sensor that detects the presence or absence of print media M in the tray 16 and cassette. Further, the sensor part 424 includes sensors (the first sensor 202, the second sensor 204) that detect the position of the print medium M conveyed by the conveyance part 12, and an encoder sensor that detects the driving amounts of various motors. The CPU 404 monitors the detection results of various sensors (detection parts) and performs control in accordance with the various detection results.

The printing apparatus 10 includes the FAX part 426, which is controlled by the CPU 404. The FAX part 426 includes, for example, a V.34/V.32/V.32bis/V.17/V.29/V.27ter/V.23/V.21 (H/L) modem and a network control unit (NCU) that connects a subscriber circuit (PSTN) and the modem. The NCU is a subscriber line interface circuit that conforms to telephone line standards of each country, performs seizure and release of a line, outgoing call and incoming call, and impedance matching, and ensures insulation between the subscriber line and the modem to transfer signals. The modem receives an analog signal from the subscriber line via the NCU, demodulates it, and stores the binarized data in the RAM 408. Alternatively, transmission data stored in the RAM 408 is modulated and sent to the subscriber line via the NCU.

The printing apparatus 10 includes the memory I/F part 428, which is controlled by the CPU 404 and to which a USB memory, a memory card, or the like can be inserted. The memory I/F part 428 includes, for example, a USB type A connector, various card slots, and a card controller IC. The memory I/F part 428 reads data stored in connected USB memories and various memory cards for printing in the printing part 14, stores data scanned by the reading part 418, and reads/writes data from host PCs.

### <Print Processing>

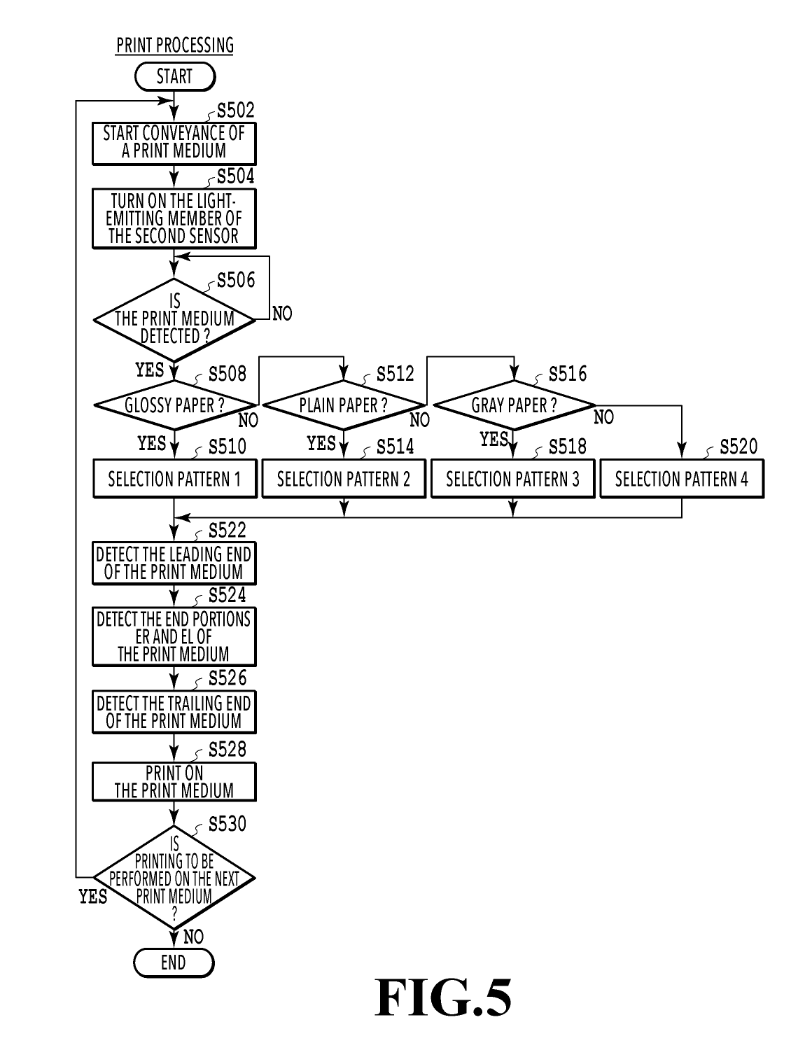

In the above-described configuration, the printing apparatus 10 executes print processing for performing printing on the print medium M based on an input job. FIG. 5 is a flowchart illustrating the details of processing of the print processing to be executed by the printing apparatus 10 according to the present embodiment. The series of processes illustrated in the flowchart of FIG. 5 is performed by the CPU 404 loading a program code stored in the ROM 406 into the RAM 408 and executing it. Alternatively, part or all of the functions in the steps of FIG. 5 may be executed by hardware such as an ASIC or an electronic circuit. In the present specification, the sign "S" in the description of each process in the flowchart indicates a step in the flowchart.

If the print processing starts, first, in S502, the CPU 404 starts feeding the print medium M, which is placed on the tray 16 or accommodated in the cassette, and conveying the fed print medium M to the printing part 14. Further, in S504, the CPU 404 turns on the light-emitting member 222 of the second sensor 204. At this time, the carriage 22 is moved in the X direction to a position where the print medium M can be detected by the second sensor 204. Then, in S506, the CPU 404 determines whether or not the print medium M is detected by the second sensor 204. In S506, a determination is made based on a detection result of the second sensor 204. For example, if the amount of light received by the light-receiving member 224 remains constant for a predetermined period of time or longer, it is determined that the print medium M is detected. Note that the method for detecting the print medium M using the second sensor 204 is not limited to this, and various known technologies can be used. If it is determined in S506 that the print medium M is detected, the processing proceeds to S508, where the CPU 404 determines whether or not the type of print medium M is glossy paper, based on the detection result of the second sensor 204.

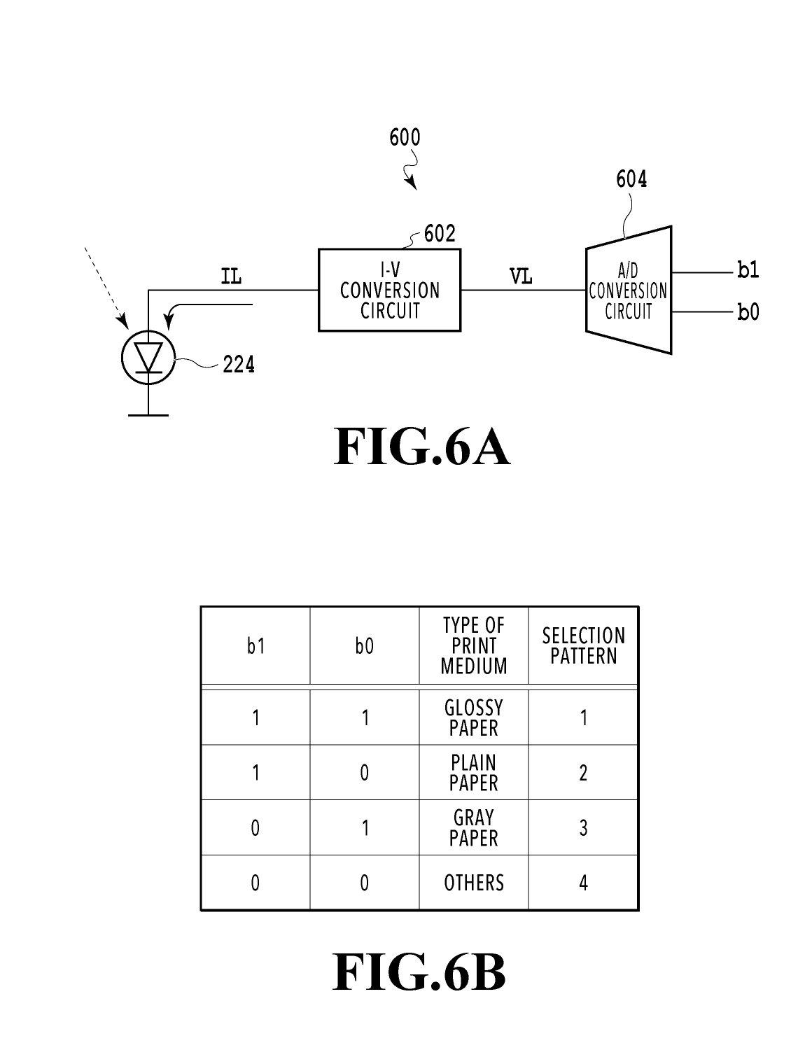

Hereinafter, with reference to FIG. 6A and FIG. 6B, a description is given about the determination of the type of print medium M based on a detection result of the second sensor 204. FIG. 6A is a diagram illustrating the determination circuit 600 that is connected to the second sensor 204 and determines the type of print medium M. FIG. 6B is a diagram illustrating a table in which data b1/b0, types of print media, and selection patterns (described later) are associated with one another.

In the second sensor 204, if the light-receiving member 224 receives the reflected light from the print medium M, the photocurrent IL flows. The photocurrent IL is converted into the voltage value VL in the current-voltage (I-V) conversion circuit 602. The voltage value VL obtained by the conversion is input to the A/D conversion circuit 604, and is compared with a preset threshold and converted into 2-bit data b1/b0 in the A/D conversion circuit 604. The CPU 404 determines the type of print medium M, based on the data b1/b0 obtained by the conversion.

In the present embodiment, there are four types of print media M: glossy paper, plain paper, gray paper, and others. The reflectivity of light of these types is assumed to be the highest for glossy paper, followed by plain paper, gray paper, and others in descending order. Hereinafter, "reflectivity of light" may be referred to simply as "reflectivity" as appropriate. The threshold used in the A/D conversion circuit 604 is set to be smaller for lower reflectivity. Furthermore, a storage area such as the ROM 406 stores the table in which, for example, data b1/b0, types of print media, and selection patterns are associated with one another (see FIG. 6B). The CPU 404 refers to this table and determines the type of print medium, based on the data b1/b0.

In the present embodiment, if the data b1/b0 is "1/1", the print medium M is determined to be glossy paper; if it is "1/0", the print medium M is determined to be plain paper; if it is "0/1", the print medium M is determined to be gray paper; and if it is "0/0", the print medium M is determined to be others. Therefore, in S508, the CPU 404 determines whether or not the data b1/b0 output from the determination circuit 600 is "1/1". As described above, in the present embodiment, the CPU 404 functions as an obtaining part that obtains the data b1/b0, which is associated with the type of print medium, as information relating to the type of print medium.

Returning to FIG. 5, the description is continued. If it is determined in S508 that the type of print medium M is glossy paper, the processing proceeds to S510. In S510, the CPU 404 selects Selection Pattern 1 as the selection pattern that is a combination of light-receiving elements 300 forming the two light-receiving parts in the first sensor 202, which are used for detecting the widthwise end portions of the print medium described later, and proceeds to S522 described later. In S510, Selection Pattern 1 associated with "1/1" of the data b1/b0 in the table of FIG. 6B is selected. The combinations of the light-receiving elements 300 selected as this Selection Pattern 1 and the later-described Selection Patterns 2 to 4 are described later.

If it is determined in S508 that the type of print medium M is not glossy paper, the processing proceeds to S512, where the CPU 404 determines whether or not the type of print medium M is plain paper. In S512, the CPU 404 determines whether or not the data b1/b0 output from the determination circuit 600 is "1/0". If it is determined in S512 that the type of print medium M is plain paper, the processing proceeds to S514, where the CPU 404 selects Selection Pattern 2 as the above-described selection pattern, and then the processing proceeds to S522 described later. In S514, Selection Pattern 2 associated with "1/0" of the data b1/b0 in the table of FIG. 6B is selected.

If it is determined in S512 that the type of print medium M is not plain paper, the processing proceeds to S516, where the CPU 404 determines whether or not the type of print medium M is gray paper. In S516, the CPU 404 determines whether or not the data b1/b0 output from the determination circuit 600 is "0/1". If it is determined in S516 that the type of print medium M is gray paper, the processing proceeds to S518, where the CPU 404 selects Selection Pattern 3 as the above-described selection pattern, and then the processing proceeds to S522 described later. In S518, Selection Pattern 3 associated with "0/1" of the data b1/b0 in the table of FIG. 6B is selected.

If it is determined in S516 that the type of print medium M is not gray paper, the processing proceeds to S520, where the CPU 404 determines that the type of print medium M is others, and selects Selection Pattern 4 as the above-described selection pattern, and then the processing proceeds to S522 described later. In S520, Selection Pattern 4 associated with "0/0" of the data b1/b0 in the table of FIG. 6B is selected. As described above, in the present embodiment, the CPU 404 functions as a setting part that sets light-receiving elements to function as the light-receiving parts from among a plurality of light-receiving elements.

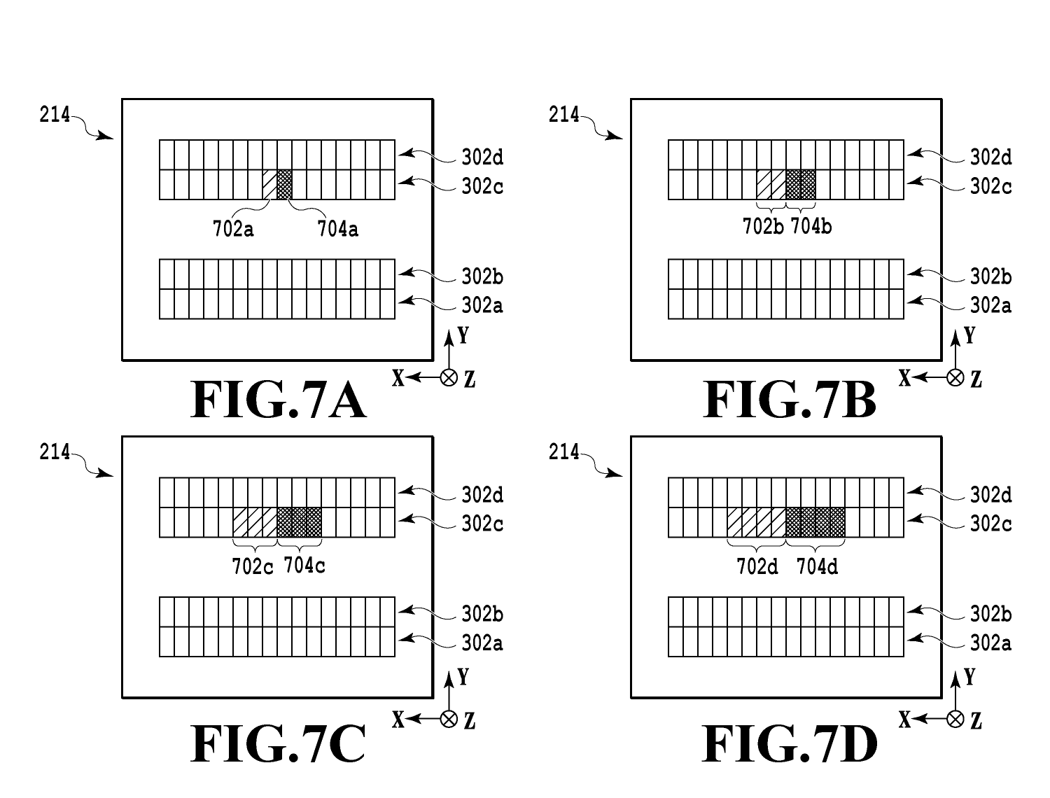

Hereinafter, a description is given about the selection patterns of the combinations of light-receiving elements 300 forming the two light-receiving parts of the first sensor 202, which are used for detecting the widthwise end portions of the print medium M, i.e., for detecting the widthwise position of the print medium M. FIG. 7A to FIG. 7D are diagrams representing the combinations of light-receiving elements 300 forming the two light-receiving parts in each selection pattern, where FIG. 7A illustrates Selection Pattern 1, FIG. 7B illustrates Selection Pattern 2, FIG. 7C illustrates Selection Pattern 3, and FIG. 7D illustrates Selection Pattern 4. Although details are described later, the first sensor 202 is configured to be able to detect the positions of the end portions of the print medium M, based on outputs from two different light-receiving parts of the light-receiving member 214. Therefore, in each selection pattern, a group of light-receiving elements 300 to function as the first light-receiving part 702 and a group of light-receiving elements 300 to function as the second light-receiving part 704 are selected from the light-receiving elements 300 in the light-receiving member 214.

In Selection Pattern 1 that is selected in a case where the type of print medium M is glossy paper, which has the highest reflectivity, two light-receiving elements located adjacent to each other at the center of the PD array 302c in the X direction are selected, so that one element serves as the first light-receiving part 702 and the other element serves as the second light-receiving part 704. Specifically, in Selection Pattern 1, one light-receiving element located on the other side of the center position in the X direction is selected as the first light-receiving part 702a, and one light-receiving element located on one side of the center position is selected as the second light-receiving part 704a (see FIG. 7A).

In Selection Pattern 2 that is selected in a case where the type of print medium M is plain paper, which has the second highest reflectivity after glossy paper, four light-receiving elements located adjacent to each other at the center of the PD array 302c in the X direction are selected, so that two elements serve as the first light-receiving part 702 and the other two elements serve as the second light-receiving part 704. Specifically, in Selection Pattern 2, two adjacent light-receiving elements located on the other side of the center position in the X direction are selected as the first light-receiving part 702b, and two adjacent light-receiving elements located on one side of the center position are selected as the second light-receiving part 704b (see FIG. 7B).

In Selection Pattern 3 that is selected in a case where the type of print medium M is gray paper, which has the third highest reflectivity after plain paper, six light-receiving elements located adjacent to each other at the center of the PD array 302c in the X direction are selected, so that three elements serve as the first light-receiving part 702 and the other three elements serve as the second light-receiving part 704. Specifically, in Selection Pattern 3, three adjacent light-receiving elements located on the other side of the center position in the X direction are selected as the first light-receiving part 702c, and three adjacent light-receiving elements located on one side of the center position are selected as the second light-receiving part 704c (see FIG. 7C).

In Selection Pattern 4 that is selected in a case where the type of print medium M is others, which have the lowest reflectivity, eight light-receiving elements located adjacent to each other at the center of the PD array 302c in the X direction are selected, so that four elements serve as the first light-receiving part 702 and the other four elements serve as the second light-receiving part 704. Specifically, in Selection Pattern 4, four adjacent light-receiving elements located on the other side of the center position in the X direction are selected as the first light-receiving part 702d, and four adjacent light-receiving elements located on one side of the center position are selected as the second light-receiving part 704d (see FIG. 7D).

As described above, in Selection Patterns 1 to 4, the number of light-receiving elements 300 forming one light-receiving part is changed depending on the type of print medium M. More specifically, in Selection Patterns 1 to 4, the number of light-receiving elements 300 forming one light-receiving part is set to increase as the reflectivity of the type of print medium M decreases. Selection Patterns 1 to 4 described above are stored in a storage area such as the ROM 406, for example.

The number of light-receiving elements 300 forming one light-receiving part in each of the above-described selection patterns is merely an example. In each selection pattern, the number of light-receiving elements 300 forming one light-receiving part may be any number as long as the number of light-receiving elements 300 is set to increase as the reflectivity of the print medium decreases. In a case of increasing the number of light-receiving elements 300, it is preferable to increase the number of light-receiving elements 300 along the movement direction of the first sensor 202 relative to the print medium M, i.e., along the X direction, but it is also possible to increase the number of light-receiving elements 300 in the Y direction. Further, in each of the above-described selection patterns, light-receiving elements of the PD array 302c are selected as the light-receiving elements that form one light-receiving part; however, there is no such limitation. As the light-receiving elements that form one light-receiving part, light-receiving elements of the PD array 302a, the PD array 302b, or the PD array 302d may be selected. Alternatively, light-receiving elements of a plurality of PD arrays 302 may be selected. Furthermore, in each of the selection patterns described above, the first light-receiving part 702 and the second light-receiving part 704 are adjacent to each other with no interval; however, there is no such limitation. In each selection pattern, the first light-receiving part 702 and the second light-receiving part 704 may be formed in a separated manner with an interval of one or more light-receiving elements between the first light-receiving part 702 and the second light-receiving part 704.

Returning to FIG. 5, the description is continued. Upon a determination of a selection pattern, in S522, the CPU 404 detects the leading end of the print medium M. In S522, the leading end of the print medium M is detected by the first sensor 202. Specifically, in S522, the carriage 22 is moved to a position where the leading end of the conveyed print medium M can be detected by the first sensor 202, and the light-emitting member 212 of the first sensor 202 is turned on. Thereafter, the position of the leading end of the print medium M is detected while the print medium M is conveyed in the +Y direction. Note that, in S522, the positions of the end portions of the print medium M in the Y-direction are detected by two pre-set light-receiving elements for detecting the leading end and trailing end of the print medium M, not by a selection pattern determined immediately before. Note that the detection of the leading end of the print medium M by the first sensor 202, which is executed in S522, is described in detail later.

If the leading end of the print medium M is detected, the processing proceeds to S524, where the CPU 404 detects the widthwise (X-direction) end portions of the print medium M. In S524, the first sensor 202 detects the end portion ER on one side (the right side) of the print medium M and the end portion EL on the other side (the left side) of the print medium M in the X direction. Specifically, in S524, the print medium M is conveyed to a position where both end portions of the print medium M in the X direction can be detected by the first sensor 202, which moves in the X direction via the carriage 22. Note that, if the light-emitting member 212 is off at the end of S522, the light-emitting member 212 is turned on at this timing. Thereafter, while the carriage 22 is being moved in the X direction, the first sensor 202 detects the positions of the end portions ER and EL of the print medium M in the X direction. Note that, in S524, two light-receiving parts (the first light-receiving part 702 and the second light-receiving part 704) in the light-receiving member 214 are set based on the selection pattern set in S510, S514, S518, or S520. Note that the detection of the end portions ER and EL of the print medium M by the first sensor 202, which is executed in S524, is described in detail later.

If the end portions ER and EL of the print medium M are detected, the processing proceeds to S526, where the CPU 404 detects the trailing end of the print medium M. In S526, the trailing end of the print medium M is detected by the first sensor 202. Specifically, in S526, the carriage 22 is moved to a position where the trailing end of the conveyed print medium can be detected by the first sensor 202. Note that, if the light-emitting member 212 is off at the end of S524, the light-emitting member 212 is turned on at this timing. Thereafter, the position of the trailing end of the print medium M is detected while the print medium M is conveyed in the +Y direction. Note that the detection of the trailing end of the print medium M by the first sensor 202, which is executed in S526, is described in detail later.

Then, in S528, the CPU 404 controls the drive part 422, the printing part 14, etc., based on the position information of the leading end, trailing end, end portion ER, and end portion EL of the print medium M, which is stored in a memory area, and performs printing on the print medium M, based on various setting information. In S528, the print medium M whose trailing end has been detected is conveyed in the −Y direction and positioned at the printing start position, and then printing on the print medium M is started. By using the position information of the end portions of the print medium M detected as described, it becomes possible to execute, for example, micro-margin printing with high accuracy, in which printing can be performed right up to the very ends of the four sides of the print medium M to obtain a visual effect equivalent to marginless printing. Thereafter, in S530, the CPU 404 determines whether or not to perform printing on the next print medium M. If it is determined in S530 that printing is to be performed on the next print medium M, the processing returns to S502. Further, if it is determined in S530 that printing is not to be performed on the next print medium, this print processing ends.

### <Detection of the End Portions of the Print Medium in the Y-direction>

Next, a description is given about detection of the leading end and trailing end of the print medium M by the first sensor 202.

### =First Light-receiving Part and Second Light-receiving Part=

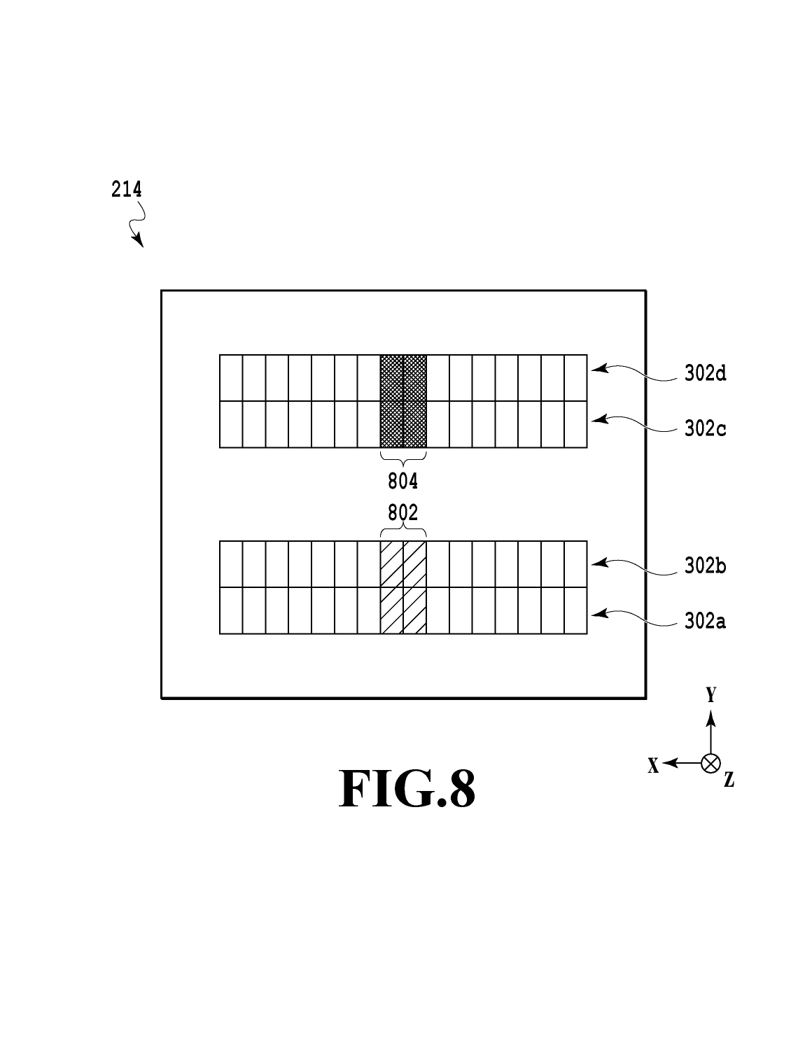

First, a description is given about the first light-receiving part and the second light-receiving part of the light-receiving member 214 at the time of detecting the leading end and trailing end of the print medium M. FIG. 8 is a diagram illustrating an example of the light-receiving elements 300 in the light-receiving member 214, which are selected as the first light-receiving part 802 and the second light-receiving part 804 at the time of detecting the leading end and trailing end of the print medium M.

At the time of detecting the leading end and trailing end of the print medium M, the same light-receiving elements 300 are selected for the first light-receiving part 802 and the second light-receiving part 804 regardless of the type of print medium M. Specifically, for the first light-receiving part 802, four light-receiving elements are selected: two light-receiving elements 300 adjacent to each other at the center position of the PD array 302a in the X direction, and two light-receiving elements 300 adjacent to each other at the center position of the PD array 302b in the X direction. Further, for the second light-receiving part 804, four light-receiving elements are selected: two light-receiving elements 300 adjacent to each other at the center position of the PD array 302c in the X direction, and two light-receiving elements 300 adjacent to each other at the center position of the PD array 302d in the X direction. Note that the light-receiving elements 300 selected as the first light-receiving part 802 and the second light-receiving part 804 are not limited to the light-receiving elements 300 described above, and may be shifted to one side or to the other side from the center position in the X direction in each PD array 302. Further, it is preferable that the first light-receiving part 802 and the second light-receiving part 804 are arranged at positions overlapping each other in the X direction, but it is also possible that one light-receiving part is located on one side relative to the center position in the X direction and the other light-receiving part is located on the other side relative to the center position. Furthermore, the first light-receiving part 802 and the second light-receiving part 804 may be arranged at any positions not overlapping each other in the Y direction. Further, the number of light-receiving elements constituting the first light-receiving part 802 and the second light-receiving part 804 is set to be constant regardless of the type of print medium M; however, there is no such limitation, and the number of light receiving elements may be changed depending on the type of print medium M. In this case, the lower the reflectivity of the print medium M, the greater the number of light-receiving elements constituting light-receiving parts. Note that the number of light-receiving elements in the first light-receiving part 802 and the second light-receiving part 804 is assumed to be the same.

### =Detection Circuit=

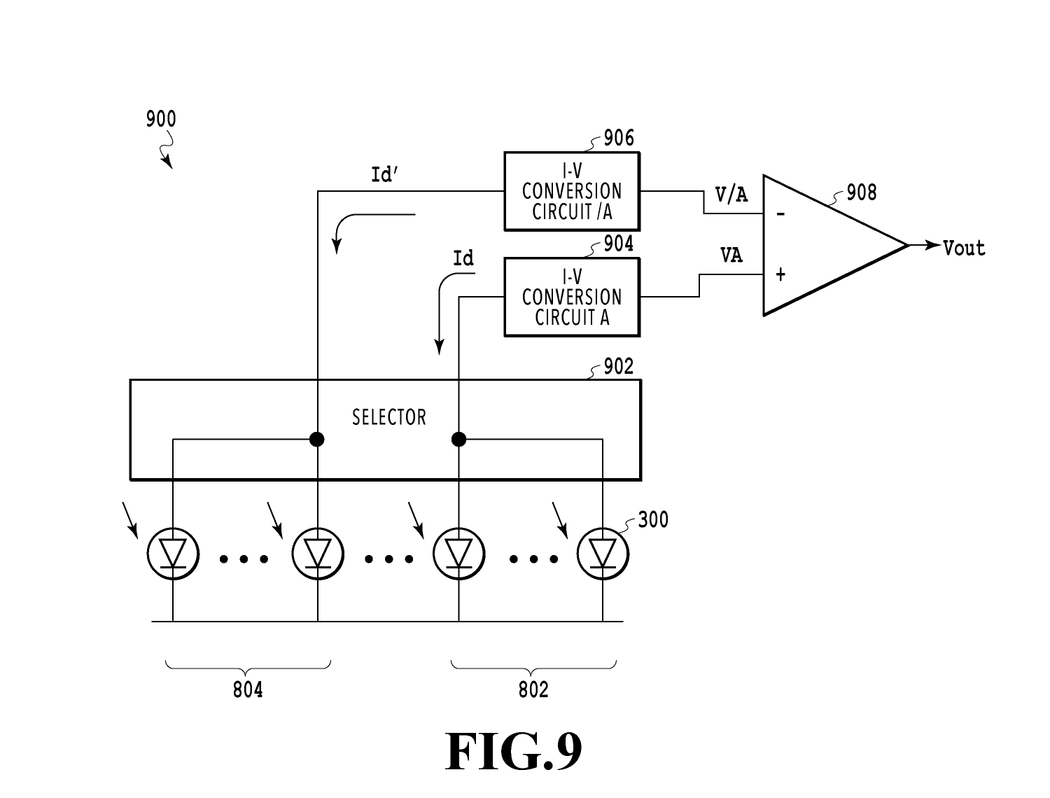

Next, a description is given about a detection circuit for detecting end portions of the print medium M. FIG. 9 is a diagram illustrating a detection circuit, which is for detecting end portions of the print medium M and is connected to the first sensor 202.

In the detection circuit 900, under the control of the CPU 404, the selector 902 sets the light-receiving elements 300 to be used for the detection. At the time of detecting the leading end and trailing end of the print medium M, the CPU 404 sets the four light-receiving elements of the PD arrays 302a and 302b described in FIG. 8 to function as the first light-receiving part 802, via the selector 902. Further, the four light-receiving elements of the PD arrays 302c and 302d described in FIG. 8 are set to function as the second light-receiving part 804.

If the CPU 404 turns on the light-emitting member 212 and the light reflected from the print medium M is input to each of the set light-receiving elements, the photocurrent Id flows in one light-receiving part and the photocurrent Id' flows in the other light-receiving part. In the present embodiment, the photocurrent Id flowing through the light-receiving elements 300 functioning as the first light-receiving part 802 is converted into the positive voltage value VA by the I-V conversion circuit 904. Further, the photocurrent Id' flowing through the light-receiving elements 300 functioning as the second light-receiving part 804 is converted into the negative voltage value V/A by the I-V conversion circuit 906. Note that the photocurrents Id and Id' make up the sum of the currents flowing through the respective light-receiving elements. Therefore, the photocurrents Id and Id' vary depending on the number of light-receiving elements used.

The voltage value VA converted by the I-V conversion circuit 904 and the voltage value V/A converted by the I-V conversion circuit 906 are input to the differential amplifier 908. In the present embodiment, the differential amplifier 908 outputs the differential signal Vout obtained by amplifying the sum of the voltage value VA and the voltage value V/A. The differential signal Vout output from the differential amplifier 908 is input to a built-in A/D converter of the CPU 404.

### =Detection of the Leading End of the Print Medium M=

Next, a description is given of the detection of the leading end of the print medium M, which is executed in S522. In S522, while the print medium M is conveyed in the +Y direction, the change in differential signal Vout based on output voltages of the first light-receiving part 802 and the second light-receiving part 804 is obtained, thereby detecting the leading end position of the print medium M based on the change.

### - Changes in Output Voltage VA, Output Voltage V/A, and Differential Signal Vout

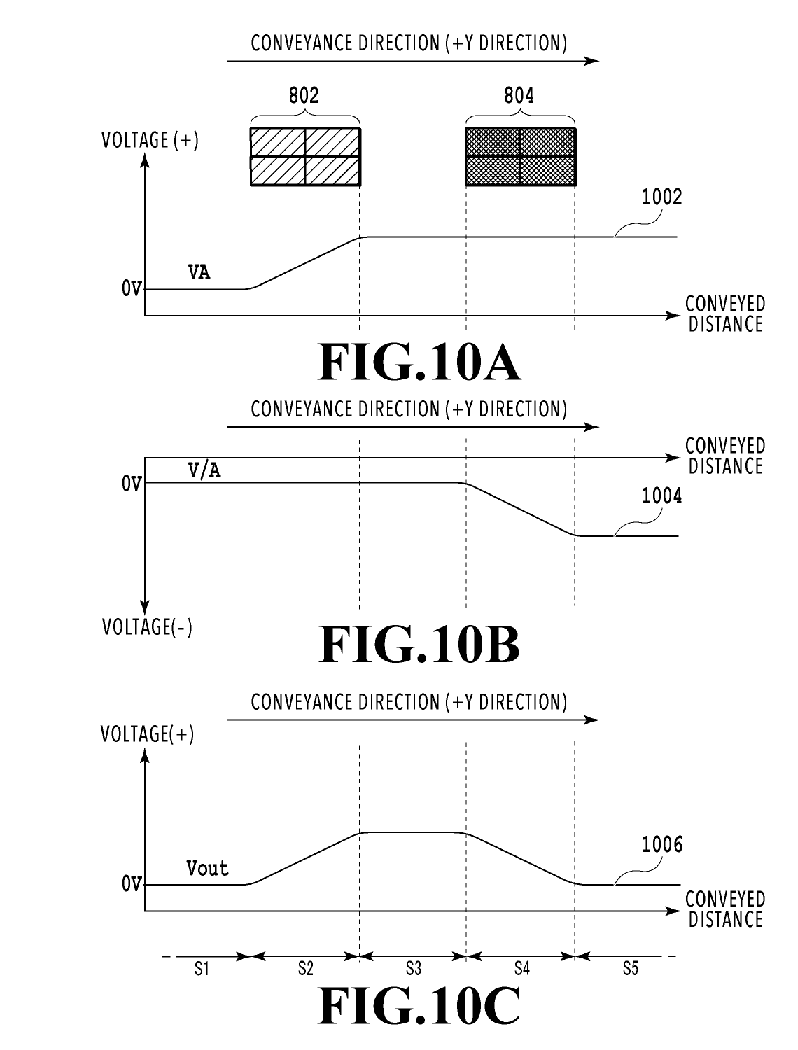

A description is given about changes in output voltage VA, output voltage V/A, and differential signal Vout in the detection circuit 900 at the time of detecting the leading end of the print medium M. FIG. 10A to FIG. 10C are diagrams describing changes in output voltages from the two light-receiving parts and a change in differential signal from the differential amplifier at the time of detecting the leading end of the print medium M. FIG. 10A is an output waveform illustrating a change in output voltage VA according to the amount of light received by the first light-receiving part 802. FIG. 10B is an output waveform illustrating a change in output voltage V/A according to the amount of light received by the second light-receiving part 804. FIG. 10C is an output waveform illustrating a change in differential signal Vout. FIG. 11A to FIG. 11E are diagrams illustrating the positions of the light-receiving member 214 relative to the print medium M being conveyed. Note that, in FIG. 11A to FIG. 11E, for ease of understanding, illustration of some configurations of the printing part 14 is omitted. Further, in FIG. 11A to FIG. 11E, the leading end of the print medium M is indicated as "EF."

First, a description is given about the change in output voltage VA. At the first sensor 202, first, the print medium M conveyed in the conveyance direction enters the light-receiving region of the first light-receiving part 802, which is located on the upstream side in the conveyance direction (+Y direction). Note that the light-receiving region refers to a region where the light-receiving part can receive reflected light from the print medium M. At the time the print medium M enters the light-receiving region of the first light-receiving part 802, the photocurrent Id starts to flow in the detection circuit 900. Further, as the proportion occupied by the print medium M in the light-receiving region increases due to conveyance of the print medium M, the amount of light received by the first light-receiving part 802 rises, and in accordance with this rise, the photocurrent Id increases, and thus the output voltage VA from the I-V conversion circuit 904 rises (see FIG. 10A). Thereafter, at the time only the print medium M is positioned in the light-receiving region of the first light-receiving part 802, the output voltage VA remains at the positive peak value. Therefore, the change in output voltage VA at the time of detecting the leading end of the print medium M is as illustrated as the output waveform 1002.

Next, a description is given about the change in output voltage V/A. At the time the print medium M is further conveyed in the conveyance direction from the state where the print medium M is positioned over the entire light-receiving region of the first light-receiving part 802, the conveyed print medium M enters the light-receiving region of the second light-receiving part 804. At the time the print medium M enters the light-receiving region of the second light-receiving part 804, the photocurrent Id' starts to flow in the detection circuit 900. Further, as the proportion occupied by the print medium M in the light-receiving region increases due to further conveyance of the print medium M, the amount of light received by the second light-receiving part 804 rises. Further, in accordance with this rise, the photocurrent Id' increases, and thus the output voltage V/A from the I-V conversion circuit 906 drops (see FIG. 10B). Thereafter, at the time only the print medium M is positioned in the light-receiving region of the second light-receiving part 804, the output voltage V/A remains at the negative peak value. Therefore, the change in output voltage V/A at the time of detecting the leading end of the print medium M is as illustrated as the output waveform 1004.

Next, a description is given about the change in differential signal Vout. The output voltage VA and the output voltage V/A are input to the differential amplifier 908, and the differential amplifier 908 outputs the differential signal Vout, which is a signal obtained by amplifying the sum of the output voltage VA and the output voltage V/A. Note that the output voltage VA rises from 0V in accordance with a rise in the amount of light received by the first light-receiving part 802 (see FIG. 10A). On the other hand, the output voltage V/A drops from 0V in accordance with a rise in the amount of light received by the second light-receiving part 804 (see FIG. 10B).

Thus, at the time the print medium M is not positioned in the light-receiving region of the first light-receiving part 802 or the light-receiving region of the second light-receiving part 804 (see FIG. 11A), the first light-receiving part 802 and the second light-receiving part 804 receive no reflected light, or hardly any reflected light. Therefore, at this time, both of the output voltage VA and the output voltage V/A are 0V, and thus the differential signal Vout is also 0V (see the region S1 in FIG. 10C).

As the conveyance of the print medium M progresses, at the time the print medium M begins to enter the light-receiving region of the first light-receiving part 802, and the proportion occupied by the print medium M in the light-receiving region is rising (see FIG. 11B), only the platen 24 is positioned in the light-receiving region of the second light-receiving part 804. Therefore, at this time, the output voltage VA rises from 0V, the output voltage V/A remains at 0V, and the differential signal Vout rises, following the rise in the output voltage VA (see the region S2 in FIG. 10C).

As the conveyance of the print medium M progresses further, at the time the leading end EF of the print medium M is positioned between the light-receiving region of the first light-receiving part 802 and the light-receiving region of the second light-receiving part 804 in the Y direction (see FIG. 11C), the print medium M is positioned over the entire light-receiving region of the first light-receiving part 802. Further, the platen 24 is positioned over the entire light-receiving region of the second light-receiving part 804. Therefore, at this time, the output voltage VA remains at the positive peak value, the output voltage V/A remains at 0V, and the differential signal Vout remains at the positive peak value (see the region S3 in FIG. 10C).

As the conveyance of the print medium M progresses further, at the time the print medium M begins to enter the light-receiving region of the second light-receiving part 804, and the proportion occupied by the print medium M in the light-receiving region is rising (see FIG. 11D), only the print medium M is located in the light-receiving region of the first light-receiving part 802. Therefore, at this time, the output voltage VA remains at the positive peak value, the output voltage V/A drops from 0V, and the differential signal Vout drops in accordance with the drop in the output voltage V/A (see the region S4 in FIG. 10C).

As the conveyance of the print medium M progresses further, at the time the print medium M is positioned over the entire light-receiving region of the second light-receiving part 804 (see FIG. 11E), the print medium M is positioned over the entire light-receiving region of the first light-receiving part 802 as well. Therefore, at this time, the output voltage VA remains at the positive peak value and the output voltage V/A remains at the negative peak value, and thus the differential signal Vout is 0V. Therefore, the change in differential signal Vout at the time of detecting the leading end of the print medium M is as illustrated as the output waveform 1006.

### - Method for Detecting the Leading End Position of the Print Medium M

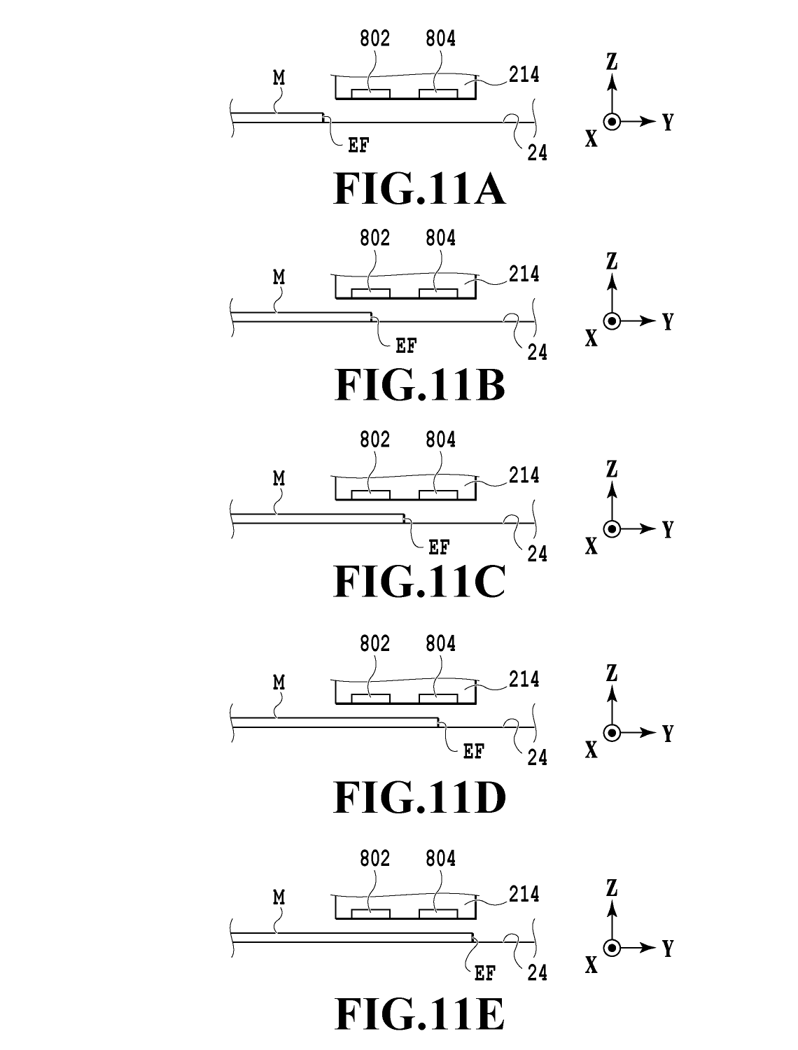

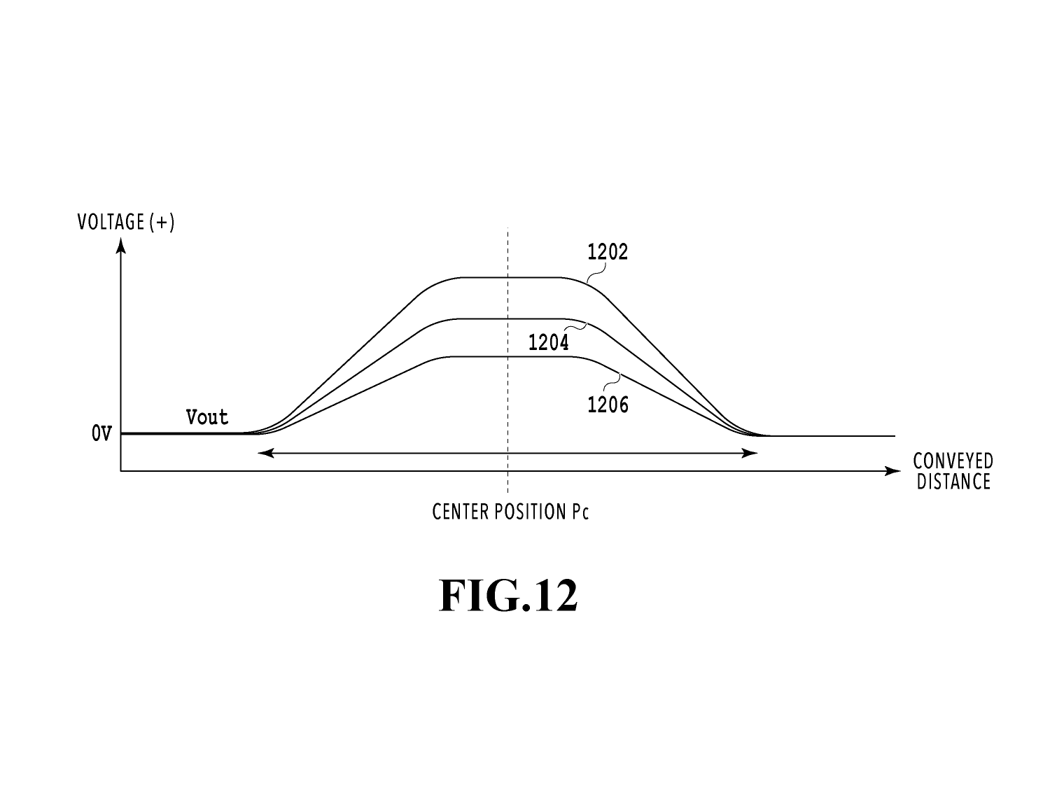

Next, a description is given about a method for detecting the leading end position of the print medium M based on the differential signal Vout. FIG. 12 is a diagram illustrating the output waveforms 1006 of the differential signal Vout at the time of detecting the leading ends of different types of print media.

At the time of detecting the leading end of the print medium M, the peak value of the differential signal Vout corresponds to the output voltage VA, and thus varies depending on the reflectivity of the print medium M (the type of print medium M). For example, in a case of detecting the leading end of glossy paper with high reflectivity, the change in differential signal Vout is indicated as the output waveform 1202. This output waveform 1202 has a higher peak value than the output waveform 1204, which illustrates the change in differential signal Vout at the time of detecting the leading end of plain paper, and the output waveform 1206, which illustrates the change in differential signal Vout at the time of detecting the leading end of gray paper.

However, in these output waveforms, even though the peak value changes depending on the type of print medium M, the width of the peak waveforms hardly changes, and the center position Pc of the peak waveforms in the width direction hardly changes. Therefore, regardless of the type of print medium M, the center position Pc of the peak waveform in the output waveform, which indicates the change in the differential signal Vout, corresponds to the leading end of the print medium M.

Therefore, in S522, the CPU 404 converts the differential signal Vout input to the A/D converter into digital data, and generates an output waveform that indicates the change in the differential signal Vout. Then, the center position Pc of the peak waveform of the generated output waveform is detected as the position of the leading end of the print medium M. The detected position information is stored as the position information of the leading end of the print medium M in a storage area such as the RAM 408. In this manner, in the present embodiment, the first sensor 202 and the CPU 404 function as a detection part that detects the print medium M and detects the position of the print medium M based on a result of that detection.

### =Detection of the Trailing End of the Print Medium M=

Next, a description is given about the detection of the trailing end of the print medium M, which is executed in S526. In S526, while the print medium M is conveyed in the +Y direction, the change in differential signal Vout based on output voltages of the first light-receiving part 802 and the second light-receiving part 804 is obtained, thereby detecting the trailing end position of the print medium M based on the change.

### - Changes in Output Voltage VA, Output Voltage V/A, and Differential Signal Vout

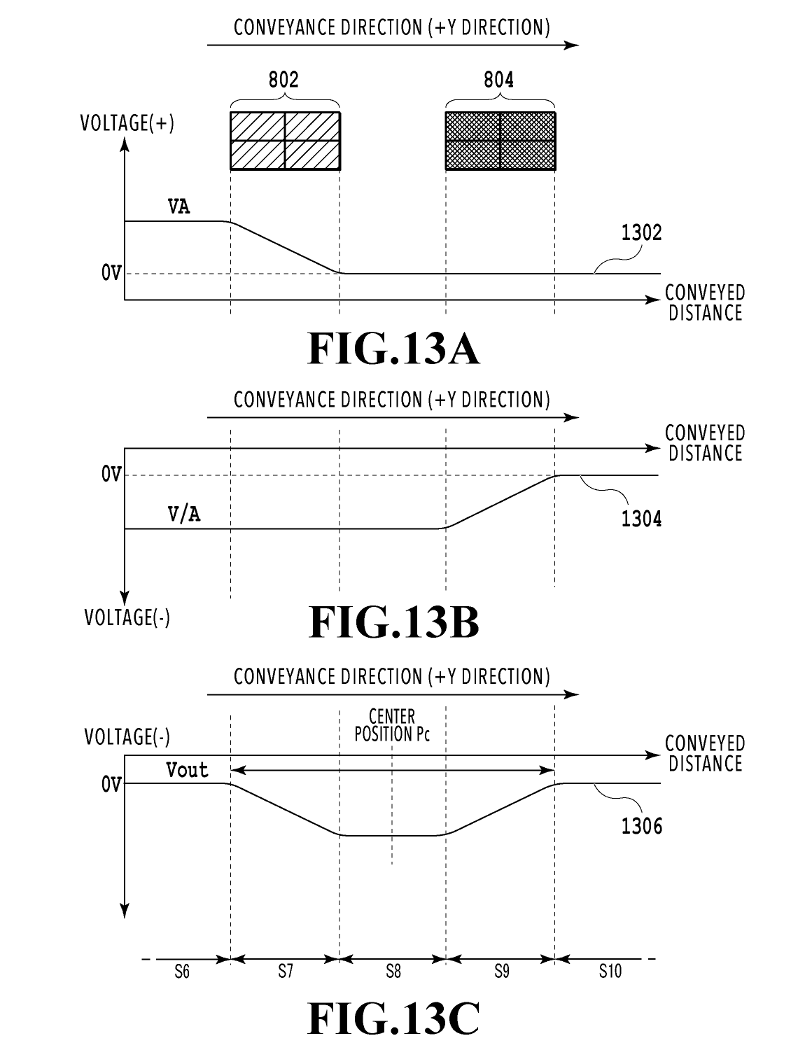

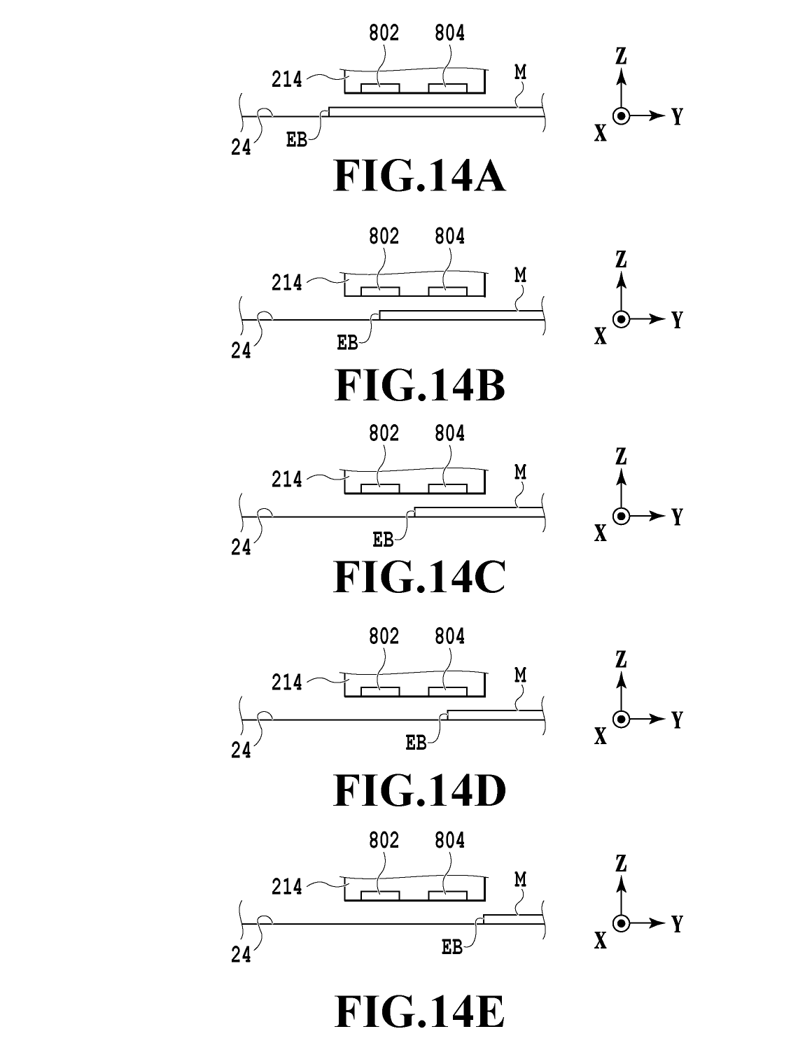

A description is given about the changes in output voltage VA, output voltage V/A, and differential signal Vout in the detection circuit 900 at the time of detecting the trailing end of the print medium M. FIG. 13A to FIG. 13C are diagrams describing the changes in output voltages from the two light-receiving parts and a change in differential signal from the differential amplifier at the time of detecting the trailing end of the print medium M. FIG. 13A is an output waveform illustrating a change in output voltage VA according to the amount of light received by the first light-receiving part 802. FIG. 13B is an output waveform illustrating a change in output voltage V/A according to the amount of light received by the second light-receiving part 804. FIG. 13C is an output waveform illustrating a change in differential signal Vout. FIG. 14A to FIG. 14E are diagrams illustrating the positions of the light-receiving member 214 relative to the print medium M being conveyed. Note that, in FIG. 14A to FIG. 14E, for ease of understanding, illustration of some configurations of the printing part 14 is omitted. Further, in FIG. 14A to FIG. 14E, the trailing end of the print medium M is indicated as "EB."

First, a description is given about the change in output voltage VA. At the first sensor 202, first, the print medium M conveyed in the conveyance direction gradually moves away from the light-receiving region of the first light-receiving part 802, which is located on the upstream side in the conveyance direction (+Y direction). Further, as the proportion occupied by the print medium M in the light-receiving region of the first light-receiving part 802 decreases, the amount of received light at the first light-receiving part 802 is reduced, and in accordance with this reduction, the photocurrent Id decreases, and thus the output voltage VA from the I-V conversion circuit 904 drops (see FIG. 13A). Thereafter, at the time the print medium M has completely moved away from the light-receiving region of the first light-receiving part 802 and only the platen 24 is positioned in the light-receiving region, the photocurrent Id stops flowing in the detection circuit 900, and the output voltage VA remains at the minimum value, i.e., 0V. Therefore, the change in output voltage VA at the time of detecting the trailing end of the print medium M is as illustrated as the output waveform 1302.

Next, a description is given about the change in output voltage V/A. At the time the print medium M is further conveyed in the conveyance direction after the print medium M has completely moved away from the light-receiving region of the first light-receiving part 802, the print medium M gradually moves away from the light-receiving region of the second light-receiving part 804. Further, as the proportion occupied by the print medium M in the light-receiving region of the second light-receiving part 804 decreases, the amount of received light at the first light-receiving part 802 is reduced, and in accordance with this reduction, the photocurrent Id' decreases, and thus the output voltage V/A from the I-V conversion circuit 906 rises (see FIG. 13B). Thereafter, at the time the print medium M has completely moved away from the light-receiving region of the second light-receiving part 804 and only the platen 24 is positioned in the light-receiving region, the photocurrent Id' stops flowing in the detection circuit 900, and the output voltage V/A remains at the maximum value, i.e., 0V. Therefore, the change in output voltage V/A at the time of detecting the trailing end of the print medium M is as illustrated as the output waveform 1304.

Next, a description is given about the change in differential signal Vout. At the time of detecting the trailing end of the print medium M, the output voltage VA drops from the positive peak value in accordance with the drop in the amount of light received by the first light-receiving part 802 (see FIG. 13A). On the other hand, the output voltage V/A rises from the negative peak value in accordance with the drop in the amount of light received by the first light-receiving part 802 (see FIG. 13B).

Therefore, at the time only the print medium M is positioned in the light-receiving region of the first light-receiving part 802 and the light-receiving region of the second light-receiving part 804 (see FIG. 14A), the output voltage VA is at the positive peak value and the output voltage V/A is at the negative peak value. Accordingly, the differential signal Vout is the sum of the positive peak value and the negative peak value, i.e., 0V (see the region S6 in FIG. 13C).

As the conveyance of the print medium M progresses, at the time the print medium M begins to move away from the light-receiving region of the first light-receiving part 802, and the proportion occupied by the print medium M in the light-receiving region is dropping (see FIG. 14B), only the print medium M is located in the light-receiving region of the second light-receiving part 804. Therefore, at this time, the output voltage VA drops from the positive peak value, the output voltage V/A remains at the negative peak value, and the differential signal Vout drops in accordance with the drop in the output voltage VA (see the region S7 in FIG. 13C).

As the conveyance of the print medium M progresses further, at the time the trailing end of the print medium M is positioned between the light-receiving region of the first light-receiving part 802 and the light-receiving region of the second light-receiving part 804 in the Y direction (see FIG. 14C), the platen 24 is positioned over the entire light-receiving region of the first light-receiving part 802. Further, the print medium M is positioned over the entire light-receiving region of the second light-receiving part 804. Therefore, at this time, the output voltage VA remains at 0V, the output voltage V/A remains at the negative peak value, and the differential signal Vout remains at the negative peak value (see the region S8 in FIG. 13C).

As the conveyance of the print medium M progresses further, at the time the print medium M begins to move away from the light-receiving region of the second light-receiving part 804, and the proportion occupied by the print medium M in the light-receiving region is dropping (see FIG. 14D), only the platen 24 is located in the light-receiving region of the first light-receiving part 802. Therefore, at this time, the output voltage VA remains at 0V, the output voltage V/A rises from the negative peak value, and the differential signal Vout rises in accordance with the rise in the output voltage V/A (see the region S9 in FIG. 13C).

As the conveyance of the print medium M progresses further, at the time the print medium M has completely moved away from the light-receiving region of the second light-receiving part 804 (see FIG. 14E), the print medium M has also completely moved away from the light-receiving region of the first light-receiving part 802. Therefore, at this time, the output voltage VA and the output voltage V/A are both 0V, and the differential signal Vout is 0V. Therefore, the change in differential signal Vout at the time of detecting the trailing end of the print medium M is as illustrated as the output waveform 1306.

### - Method for Detecting the Trailing End Position of the Print Medium M

Next, a description is given about a method for detecting the trailing end position of the print medium M based on the differential signal Vout. At the time of detecting the trailing end of the print medium M, the peak value of the differential signal Vout corresponds to the output voltage V/A, and thus varies depending on the reflectivity of the print medium M (the type of print medium M). Although not illustrated in the drawings, for example, the peak value of the differential signal Vout at the time of detecting the trailing end of glossy paper with high reflectivity is greater (greater on the negative side) than the peak values of the differential signals Vout at the time of detecting the trailing end of plain paper, gray paper, and others.

However, in the output waveforms of the differential signals Vout, even if the peak value changes depending on the type of print medium M, the width of the peak waveforms hardly changes, and the center position Pc of the peak waveforms hardly changes, just as at the time of detecting the leading end of the print medium M.

Therefore, regardless of the type of print medium M, the center position Pc of the peak waveform in the output waveform, which indicates the change in the differential signal Vout, corresponds to the trailing end of the print medium M.

Therefore, in S526, the CPU 404 converts the differential signal Vout input to the A/D converter into digital data, and generates an output waveform that indicates the change in the differential signal Vout. Then, the center position Pc of the peak waveform of the generated output waveform is detected as the position of the trailing end of the print medium M. The position information of the detected center position Pc is stored as the position information of the trailing end of the print medium M in a storage area such as the RAM 408.

### <Detection of the End Portions of the Print Medium M in the X-direction>

Next, a description is given about detection of the end portion ER and the end portion EL of the print medium M by the first sensor 202.

### =First Light-receiving Part and Second Light-receiving Part=

At the time of detecting the end portions ER and EL of the print medium M, the first light-receiving part 702 and the second light-receiving part 704 are set based on the selection pattern selected in S510, S514, S518, or S520.

For example, assume that Selection Pattern 2 is selected in S514. At this time, the CPU 404 sets two adjacent light-receiving elements 300 located on the other side of the center position of the PD array 302c in the X direction, via the selector 902 in the detection circuit 900, to function as the first light-receiving part 702. Further, the CPU 404 sets two adjacent light-receiving elements 300 located on the one side of the center position of the PD array 302c in the X direction, via the selector 902 in the detection circuit 900, to function as the second light-receiving part 704 (see FIG. 7B).

=Detection of the End Portion ER of the Print Medium M=

Next, a description is given about the detection of the end portion ER of the print medium M, which is executed in S524. In S524, in the state where the print medium M is located at a position where the end portions ER and EL of the print medium M can be detected by the first sensor 202 which moves in the X direction via the carriage 22, the end portion ER of the print medium M is detected while the first sensor 202 is moved in the +X direction. Specifically, while moving the first sensor 202 in the +X direction, the change in differential signal Vout based on output voltages of the first light-receiving part 702 and the second light-receiving part 704 is obtained, and based on this change, the position information of the end portion ER on one side of the print medium M is detected.

### - Changes in Output Voltage VA, Output Voltage V/A, and Differential Signal Vout

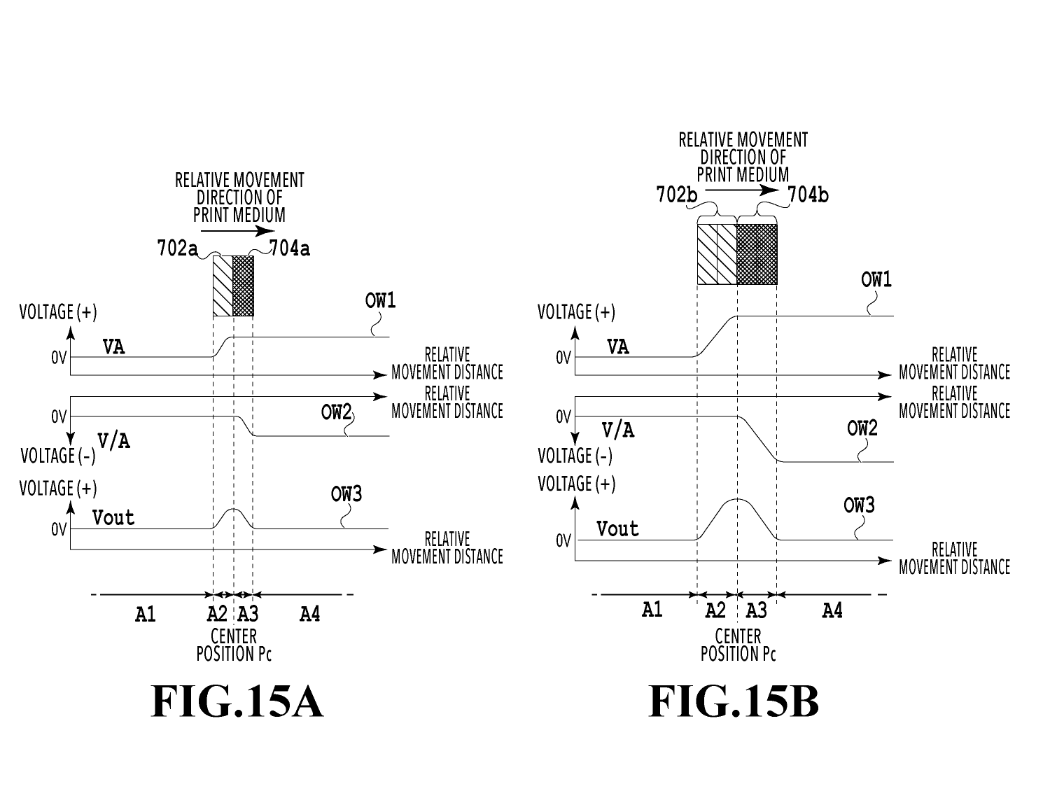

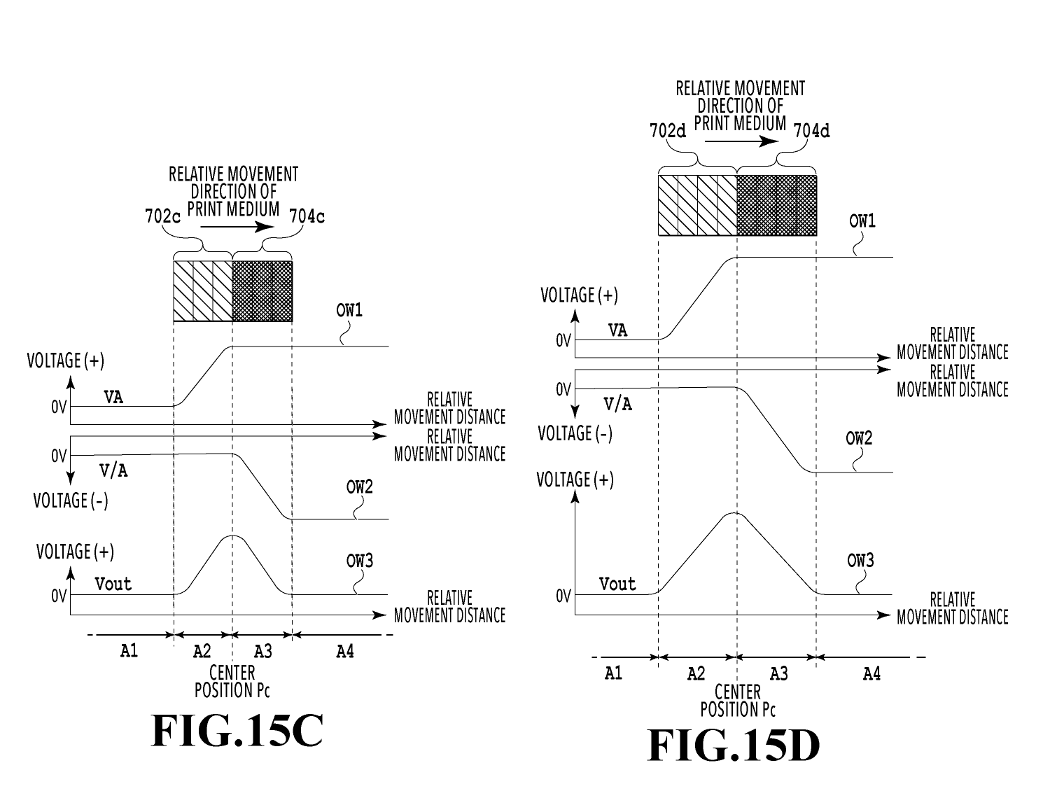

A description is given about changes in output voltage VA, output voltage V/A, and differential signal Vout in the detection circuit 900 at the time of detecting the end portion ER of the print medium M. FIG. 15A to FIG. 15D are diagrams describing changes in output voltages from the two light-receiving parts and a change in differential signal from the differential amplifier at the time of detecting the end portion ER of the print medium M. FIG. 15A illustrates an output waveform indicating a change in output voltage VA from the first light-receiving part 702, an output waveform indicating a change in output voltage V/A from the second light-receiving part 704, and an output waveform indicating a change in differential signal Vout, based on Selection Pattern 1. FIG. 15B illustrates an output waveform indicating a change in output voltage VA from the first light-receiving part 702, an output waveform indicating a change in output voltage V/A from the second light-receiving part 704, and an output waveform indicating a change in differential signal Vout, based on Selection Pattern 2. FIG. 15C illustrates an output waveform indicating a change in output voltage VA from the first light-receiving part 702, an output waveform indicating a change in output voltage V/A from the second light-receiving part 704, and an output waveform indicating a change in differential signal Vout, based on Selection Pattern 3. FIG. 15D illustrates an output waveform indicating a change in output voltage VA from the first light-receiving part 702, an output waveform indicating a change in output voltage V/A from the second light-receiving part 704, and an output waveform indicating a change in differential signal Vout, based on Selection Pattern 4.

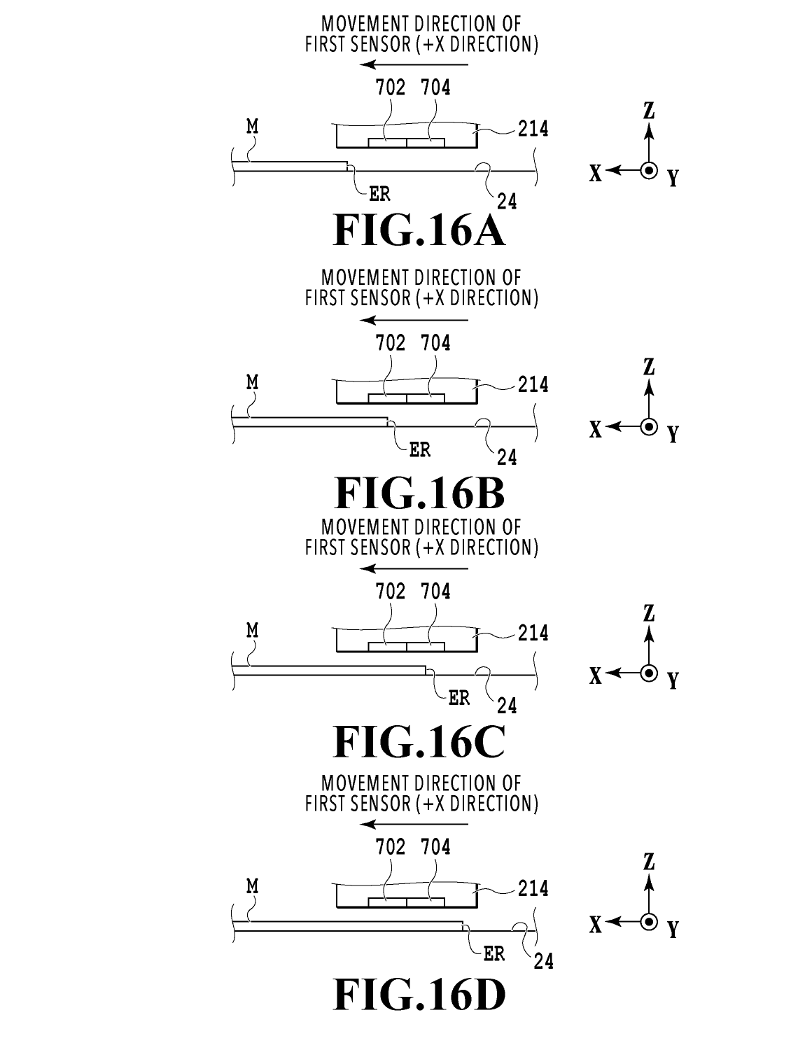

FIG. 16A to FIG. 16D are diagrams illustrating the positions of the light-receiving member 214 relative to the print medium M. Note that, in FIG. 16A to FIG. 16D, for ease of understanding, illustration of some configurations of the printing part 14 is omitted. Further, since FIG. 15A to FIG. 15D illustrate a case of detecting the end portion ER of the same type of print medium M, the peak waveform in each output waveform becomes greater as the number of light-receiving elements in the light-receiving parts increases. Note that, in FIG. 15A to FIG. 15D, the arrows above the light-receiving parts 702 and 704 indicate the movement direction of the print medium M relative to the first sensor 202.

First, a description is given about the change in output voltage VA. At the first sensor 202, first, if the print medium M enters the light-receiving region of the first light-receiving part 702 located on the downstream side in the movement direction (+X direction), the photocurrent Id starts to flow in the detection circuit 900. Further, as the proportion occupied by the print medium M in the light-receiving region increases due to the movement of the first sensor 202, the amount of light received by the first light-receiving part 702 rises, and in accordance with this rise, the photocurrent Id increases, and thus the output voltage VA from the I-V conversion circuit 904 rises. Thereafter, at the time only the print medium M is positioned in the light-receiving region of the first light-receiving part 702, the output voltage VA remains at the positive peak value. Therefore, the changes in output voltage VA at the time of detecting the end portion ER of the print medium M are as illustrated as the output waveforms OW1 (see FIG. 15A to FIG. 15D).

Next, a description is given about the change in output voltage V/A. If the first sensor 202 is further moved in the movement direction from the state where the print medium M is positioned over the entire light-receiving region of the first light-receiving part 702, the print medium M enters the light-receiving region of the second light-receiving part 704. At the time the print medium M enters the light-receiving region of the second light-receiving part 704, the photocurrent Id' starts to flow in the detection circuit 900. Further, as the proportion occupied by the print medium M in the light-receiving region increases due to the further movement of the first sensor 202, the amount of light received by the second light-receiving part 704 rises, and in accordance with this rise, the photocurrent Id' increases, and thus the output voltage V/A from the I-V conversion circuit 906 drops. Thereafter, at the time only the print medium M is positioned in the light-receiving region of the second light-receiving part 704, the output voltage V/A remains at the negative peak value. Therefore, the changes in output voltage V/A at the time of detecting the end portion ER of the print medium M are as illustrated as the output waveforms OW2 (see FIG. 15A to FIG. 15D).

Next, a description is given about the change in differential signal Vout. At the time of detecting the end portion ER of the print medium M, the output voltage VA rises from 0V in accordance with the rise in the amount of light received by the first light-receiving part 702 (see the output waveforms OW1 in FIG. 15A to FIG. 15D). On the other hand, the output voltage V/A drops from 0V in accordance with the rise in the amount of light received by the second light-receiving part 704 (see the output waveforms OW2 in FIG. 15A to FIG. 15D).

Thus, at the time the print medium M is not positioned in the light-receiving region of the first light-receiving part 702 nor the light-receiving region of the second light-receiving part 704 (see FIG. 16A), the first light-receiving part 702 and the second light-receiving part 704 receive no reflected light, or hardly any reflected light. Therefore, at this time, both of the output voltage VA and the output voltage V/A are 0V, and the differential signal Vout is 0V (see the region A1 in FIG. 15A to FIG. 15D).

As the movement of the first sensor 202 progresses, at the time the print medium M begins to enter the light-receiving region of the first light-receiving part 702, and the proportion occupied by the print medium M in the light-receiving region is rising (see FIG. 16B), the platen 24 is positioned in the light-receiving region of the second light-receiving part 704. Therefore, at this time, the output voltage VA rises from 0V and the output voltage V/A remains at 0V, and thus the differential signal Vout rises, following the rise in the output voltage VA (see the region A2 in FIG. 15A to FIG. 15D).

As the movement of the first sensor 202 further progresses, at the time the print medium M begins to enter the light-receiving region of the second light-receiving part 704, and the proportion occupied by the print medium M in the light-receiving region is rising (see FIG. 16C), only the print medium M is located in the light-receiving region of the first light-receiving part 702. Therefore, at this time, the output voltage VA remains at the positive peak value and the output voltage V/A drops from 0V, and thus the differential signal Vout drops in accordance with the drop in the output voltage V/A (see the region A3 in FIG. 15A to FIG. 15D).

As the movement of the first sensor 202 further progresses, at the time the print medium M is positioned over the entire light-receiving region of the second light-receiving part 704 (see FIG. 16D), the print medium M is positioned over the entire light-receiving region of the first light-receiving part 702 as well. Therefore, at this time, the output voltage VA remains at the positive peak value and the output voltage V/A remains at the negative peak value, and thus the differential signal Vout is 0V (see the region A4 in FIG. 15A to FIG. 15D). Therefore, the changes in differential signal Vout at the time of detecting the end portion ER of the print medium M are as illustrated as the output waveforms OW3 (see FIG. 15A to FIG. 15D).

### - Detection of the Position of the End Portion ER of the Print Medium M

Next, a description is given about a method for detecting the position of the end portion ER of the print medium M based on the differential signal Vout. In the same way as at the time of detecting the leading end position, the center position Pc of the width of the peak waveform in the output waveform is detected. Then, the position information of the detected center position Pc is stored in a storage area as the position information of the end portion EL of the print medium M. Note that the method for detecting the center position Pc is not limited to this. At the time of detecting the end portion ER of the print medium M, the number of light-receiving elements constituting the first light-receiving part 702 and the second light-receiving part 704 is selected according to the type of print medium M. Accordingly, the peak value of the differential signal Vout becomes greater than a predetermined value. That is, the number of light-receiving elements constituting the first light-receiving part 702 and the second light-receiving part 704 is adjusted so that the peak value of the differential signal Vout becomes greater than the predetermined value. Therefore, at the time of detecting the center position Pc, a position where the value of the differential signal Vout exceeds a preset threshold (a value smaller than the predetermined value) and a position where it falls below the threshold may be obtained, so as to detect the intermediate position between them as the center position Pc.

### Detection of the End Portion EL of the Print Medium M

Next, a description is given of the detection of the end portion EL of the print medium M, which is executed in S524. In S524, in the state where the print medium M is located at a position where the end portions ER and EL of the print medium M can be detected by the first sensor 202 which moves in the X direction via the carriage 22, the end portion EL of the print medium M is detected while the first sensor 202 is moved in the −X direction. Specifically, while moving the first sensor 202 in the −X direction, the change in differential signal Vout based on the output voltages of the first light-receiving part 702 and the second light-receiving part 704 is obtained, and based on this change, the position information of the end portion EL on the other side of the print medium M is obtained. Note that, in S524, as for the order of executing the detection of the end portion ER and the detection of the end portion EL of the print medium M, it is possible to execute the detection of the end portion ER first, and then execute the detection of the end portion EL, or vice versa.

### - Changes in Output Voltage VA, Output Voltage V/A, and Differential Signal Vout

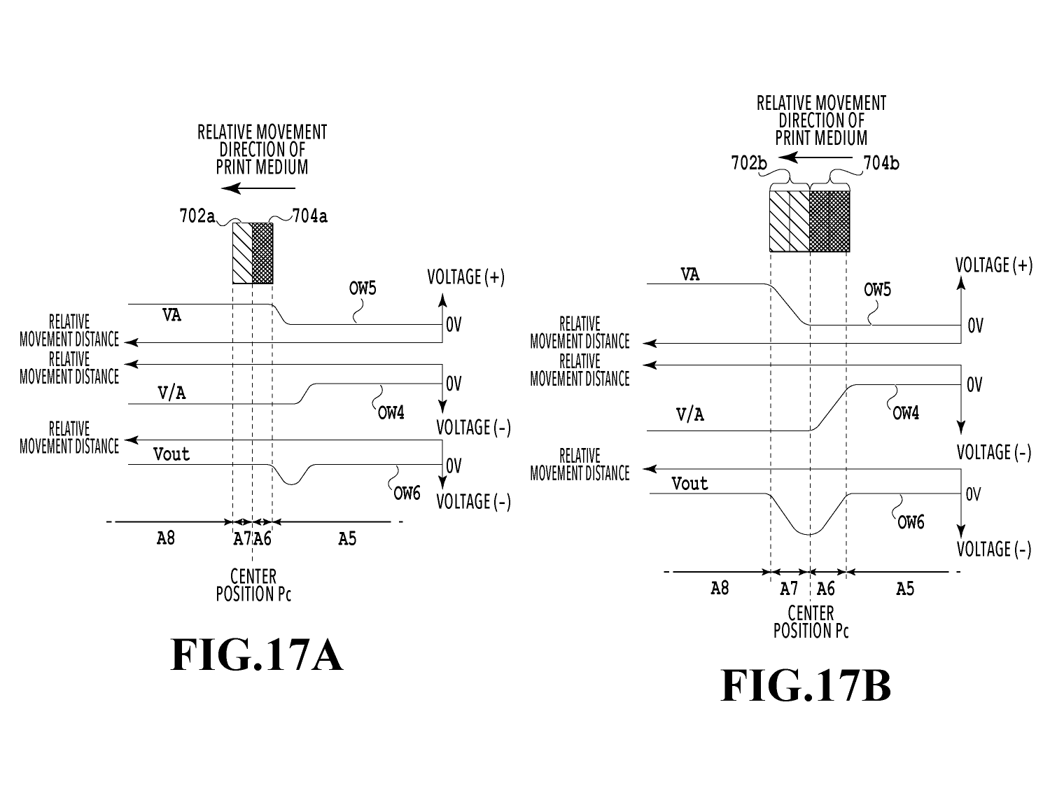

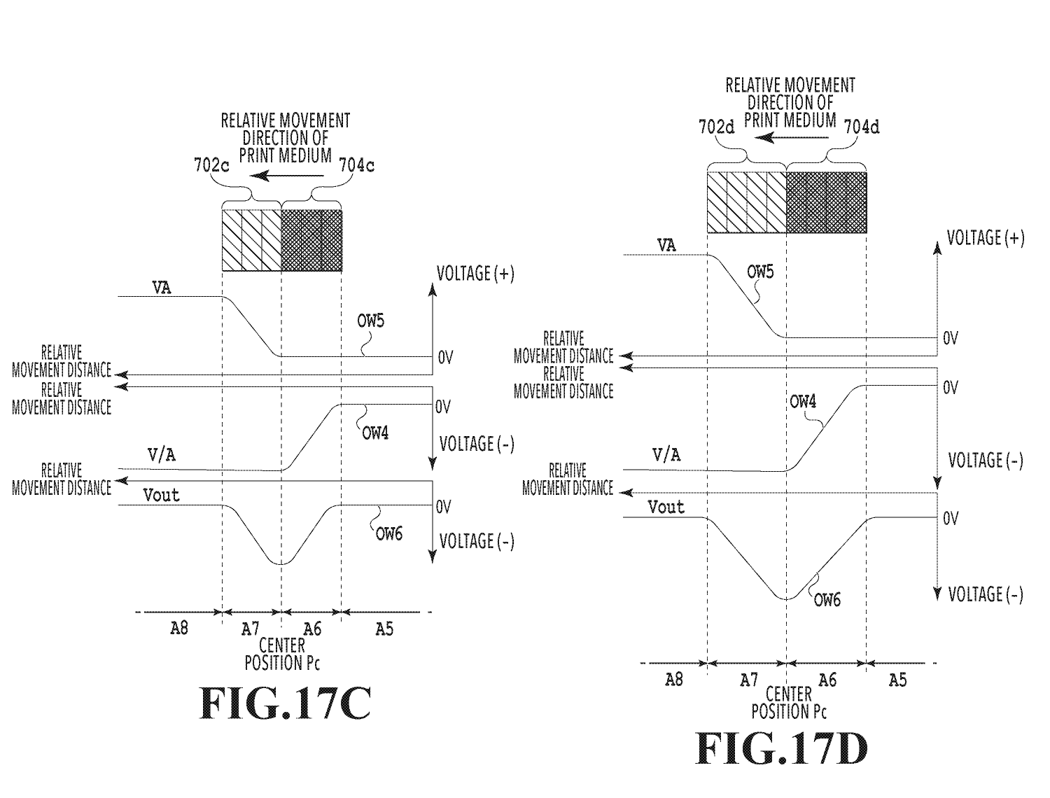

A description is given about changes in output voltage VA, output voltage V/A, and differential signal Vout in the detection circuit 900 at the time of detecting the end portion EL of the print medium M. FIG. 17A to FIG. 17D are diagrams describing changes in output voltages from the two light-receiving parts and a change in differential signal from the differential amplifier at the time of detecting the end portion EL of the print medium M. FIG. 17A illustrates an output waveform indicating a change in output voltage VA from the first light-receiving part 702, an output waveform indicating a change in output voltage V/A from the second light-receiving part 704, and an output waveform indicating a change in differential signal Vout, based on Selection Pattern 1. FIG. 17B illustrates an output waveform indicating a change in output voltage VA from the first light-receiving part 702, an output waveform indicating a change in output voltage V/A from the second light-receiving part 704, and an output waveform indicating a change in differential signal Vout, based on Selection Pattern 2. FIG. 17C illustrates an output waveform indicating a change in output voltage VA from the first light-receiving part 702, an output waveform indicating a change in output voltage V/A from the second light-receiving part 704, and an output waveform indicating a change in differential signal Vout, based on Selection Pattern 3. FIG. 17D illustrates an output waveform indicating a change in output voltage VA from the first light-receiving part 702, an output waveform indicating a change in output voltage V/A from the second light-receiving part 704, and an output waveform indicating a change in differential signal Vout, based on Selection Pattern 4.

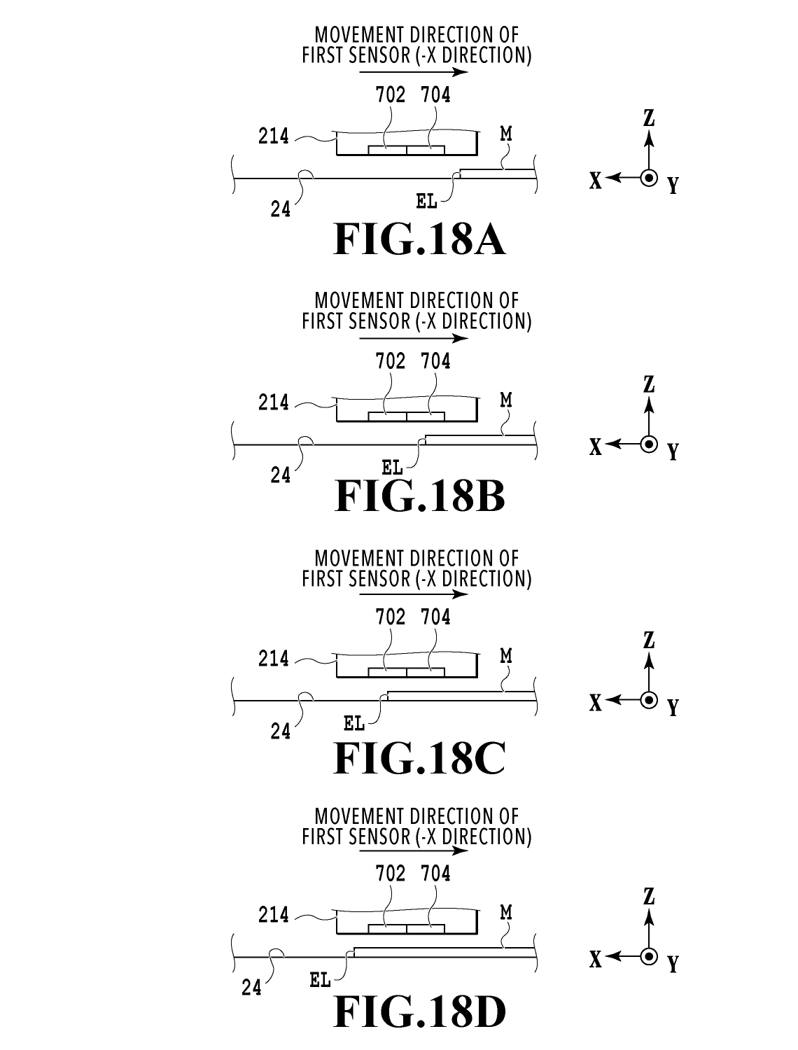

FIG. 18A to FIG. 18D are diagrams illustrating the positions of the light-receiving member 214 relative to the print medium M. Note that, in FIG. 18A to FIG. 18D, for ease of understanding, illustration of some configurations of the printing part 14 is omitted. Further, since FIG. 17A to FIG. 17D illustrate a case of detecting the end portion EL of the same type of print medium M, the peak waveform in each output waveform becomes greater as the number of light-receiving elements in the light-receiving parts increases. Note that, in FIG. 17A to FIG. 17D, the arrows above the light-receiving parts 702 and 704 indicate the movement direction of the print medium M relative to the first sensor 202.

First, a description is given about the change in output voltage V/A. At the first sensor 202, first, if the print medium M enters the light-receiving region of the second light-receiving part 704 located on the downstream side in the movement direction (−X direction), the photocurrent Id' starts to flow in the detection circuit 900. Further, as the proportion occupied by the print medium M in the light-receiving region increases due to the movement of the first sensor 202, the amount of light received by the second light-receiving part 704 rises, and in accordance with this rise, the photocurrent Id' increases, and thus the output voltage V/A from the I-V conversion circuit 906 drops. Thereafter, at the time only the print medium M is positioned in the light-receiving region of the second light-receiving part 704, the change in the output voltage V/A remains at the negative peak value. Therefore, the output voltages V/A at the time of detecting the end portion EL of the print medium M are as illustrated as the output waveforms OW4 (see FIG. 17A to FIG. 17D).

Next, a description is given about the change in output voltage VA. If the first sensor 202 is further moved in the movement direction from the state where the print medium M is positioned over the entire light-receiving region of the second light-receiving part 704, the print medium M enters the light-receiving region of the first light-receiving part 702. At the time the print medium M enters the light-receiving region of the first light-receiving part 702, the photocurrent Id starts to flow in the detection circuit 900. Further, as the proportion occupied by the print medium M in the light-receiving region increases due to the further movement of the first sensor 202, the amount of light received by the first light-receiving part 702 rises, and in accordance with this rise, the photocurrent Id increases, and thus the output voltage VA from the I-V conversion circuit 904 rises. Thereafter, at the time only the print medium M is positioned in the light-receiving region of the first light-receiving part 702, the output voltage VA remains at the positive peak value. Therefore, the changes in output voltage VA at the time of detecting the end portion EL of the print medium M are as illustrated as the output waveforms OW5 (see FIG. 17A to FIG. 17D).

Next, a description is given about the change in differential signal Vout. At the time of detecting the end portion EL of the print medium M, the output voltage V/A drops from 0V in accordance with the rise in the amount of light received by the second light-receiving part 704 (see the output waveforms OW4 in FIG. 17A to FIG. 17D). On the other hand, the output voltage VA rises from 0V in accordance with the rise in the amount of light received by the first light-receiving part 702 (see the output waveforms OW5 in FIG. 17A to FIG. 17D).

Thus, at the time the print medium M is not positioned in the light-receiving region of the first light-receiving part 702 nor the light-receiving region of the second light-receiving part 704 (see FIG. 18A), the first light-receiving part 702 and the second light-receiving part 704 receive no reflected light, or hardly any reflected light. Therefore, at this time, both of the output voltage V/A and the output voltage VA are 0V, and thus the differential signal Vout is 0V (see the region A5 in FIG. 17A to FIG. 17D).

As the movement of the first sensor 202 progresses, at the time the print medium M begins to enter the light-receiving region of the second light-receiving part 704, and the proportion occupied by the print medium M in the light-receiving region is rising (see FIG. 18B), the platen 24 is positioned in the light-receiving region of the first light-receiving part 702. Therefore, at this time, the output voltage V/A drops from 0V, the output voltage VA remains at 0V, and the differential signal Vout drops, following the drop in the output voltage V/A (see the region A6 in FIG. 17A to FIG. 17D).

As the movement of the first sensor 202 further progresses, at the time the print medium M begins to enter the light-receiving region of the first light-receiving part 702, and the proportion occupied by the print medium M in the light-receiving region is rising (see FIG. 18C), only the print medium M is located in the light-receiving region of the second light-receiving part 704. Therefore, at this time, the output voltage V/A remains at the negative peak value and the output voltage VA rises from 0V, and thus the differential signal Vout rises in accordance with the rise in the output voltage VA (see the region A7 in FIG. 17A to FIG. 17D).

As the movement of the first sensor 202 further progresses, and the print medium M is positioned over the entire light-receiving region of the first light-receiving part 702 (see FIG. 18D), the print medium M is positioned over the entire light-receiving region of the second light-receiving part 704 as well. Therefore, at this time, the output voltage V/A remains at the negative peak value and the output voltage VA remains at the positive peak value, and thus the differential signal Vout is 0V (see the region A8 in FIG. 17A to FIG. 17D). Therefore, the changes in differential signal Vout at the time of detecting the end portion EL of the print medium M are as illustrated as the output waveforms OW6.

### - Detection of the Position of the End Portion EL of the Print Medium M

Next, a description is given about a method for detecting the position of the end portion EL of the print medium M based on the differential signal Vout. In the same way as at the time of detecting the leading end position, the center position Pc of the width of the peak waveform in the output waveform is detected. Then, the position information of the detected center position Pc is stored in a storage area, such as the RAM 408, as the position information of the end portion EL of the print medium M. Note that the method for detecting the center position Pc is not limited to this. At the time of detecting the end portion EL of the print medium M, the number of light-receiving elements constituting the first light-receiving part 702 and the second light-receiving part 704 is selected according to the type of print medium M. Accordingly, the peak value of the differential signal Vout becomes greater than a predetermined value. Therefore, at the time of detecting the center position Pc, a position where the value of the differential signal Vout exceeds a preset threshold (a value smaller than the predetermined value) and a position where it falls below the threshold may be obtained, so as to detect the intermediate position between them as the center position Pc.

### <Registration Adjustment>

Next, a description is given about detection of a position detection patch during registration adjustment. The printing apparatus 10 has a registration adjustment function for adjusting deviations in landing positions of ink deposited by the print head 20. During registration adjustment, after a pattern for registration adjustment (registration adjustment pattern) is printed on the print medium, the print medium is pulled back (conveyed in the −Y direction) and then conveyed again in the conveyance direction (+Y direction), and thus the registration adjustment pattern is read by the second sensor 204. In a case where a registration adjustment pattern is printed on each side of the print medium, the conveyance and pull-back of the print medium are repeatedly executed. Therefore, at the time the second sensor 204 detects (reads) the registration adjustment pattern, the position of the print medium may be shifted in the X direction, and in this case, accurate registration adjustment cannot be executed.

Therefore, in the present embodiment, at the time of printing a registration adjustment pattern, a plurality of position detection patches is printed on the downstream side of the print medium in the conveyance direction, so as to be used at the time the second sensor 204 reads the registration adjustment pattern. Further, during the registration adjustment, the first sensor 202 detects the position detection patches.

### =Position Detection Patches=

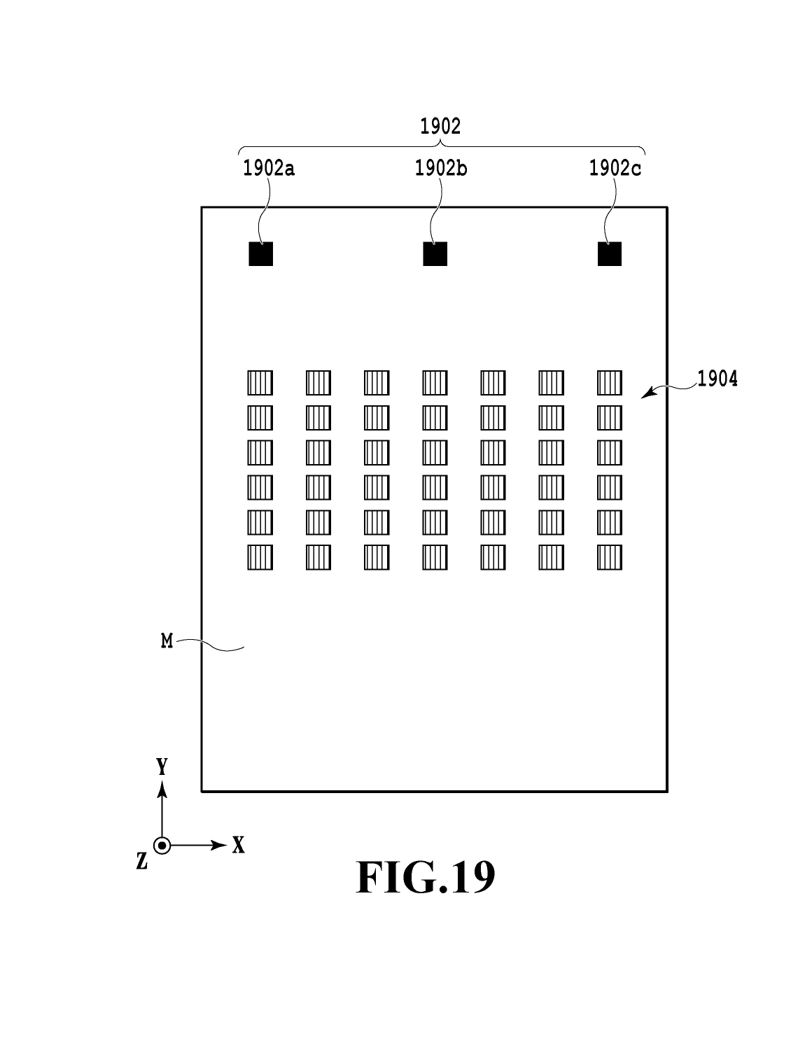

FIG. 19 is a diagram illustrating position detection patches according to the present embodiment. The position detection patches 1902 in FIG. 19 are printed on the downstream side of the print medium M in the conveyance direction (+Y direction) relative to the registration adjustment pattern 1904. In the present embodiment, the three position detection patches 1902a, 1902b, and 1902c are arranged along the X direction, and each of the position detection patches 1902 is arranged with a predetermined interval between adjacent position detection patches. Note that the predetermined interval is set to be longer than the length of each position detection patch 1902 in the X direction, for example. Further, each position detection patch 1902 is, for example, a solid black square.

During registration adjustment, in a case where the registration adjustment pattern 1904 does not fit on one side of the print medium M, the registration adjustment pattern 1904 that could not be printed on that side is printed on the other side of the print medium M. At this time, the position detection patches 1902 are printed on the other side, on the downstream side of the registration adjustment pattern 1904 in the conveyance direction. Note that the position detection patches 1902 are used to read the position of the print medium M before reading the registration adjustment pattern 1904 printed on the print medium M. Further, the position detection patches 1902 are also utilized as reference positions for grasping the contents of each patch of the registration adjustment pattern 1904. Note that the number of position detection patches 1902 is not limited to three, and may be two, or four or more. Further, the position detection patches 1902 are solid black, but are not limited as such, and may have other colors or patterns as long as the difference in reflectivity compared with unprinted print medium M is large.

### =Detection of the Position Detection Patches=

Next, a description is given about detection of a position detection patch. At the time of printing a position detection pattern together with a registration adjustment pattern, as the pre-processing for the printing, the light-receiving elements 300 that form the first light-receiving part 702 and the second light-receiving part 704 in the first sensor 202 are set based on the type of print medium M. Note that the setting of the light-receiving elements 300 of the first light-receiving part 702 and the second light-receiving part 704 based on the type of print medium M is the same as that described in the print processing above, and thus the description thereof is omitted.

In the present embodiment, in the state where the print medium M is located at a position where the printed position detection patches 1902 can be detected by the first sensor 202 which moves in the X direction via the carriage 22, the position detection patches 1902 are detected while the first sensor 202 is moved in the +X direction. Specifically, while moving the first sensor 202 in the +X direction, the change in differential signal Vout based on output voltages of the first light-receiving part 702 and the second light-receiving part 704 is obtained, and based on this change, the position detection patches 1902 are detected.

### - Changes in Output Voltage VA, Output Voltage V/A, and Differential Signal Vout

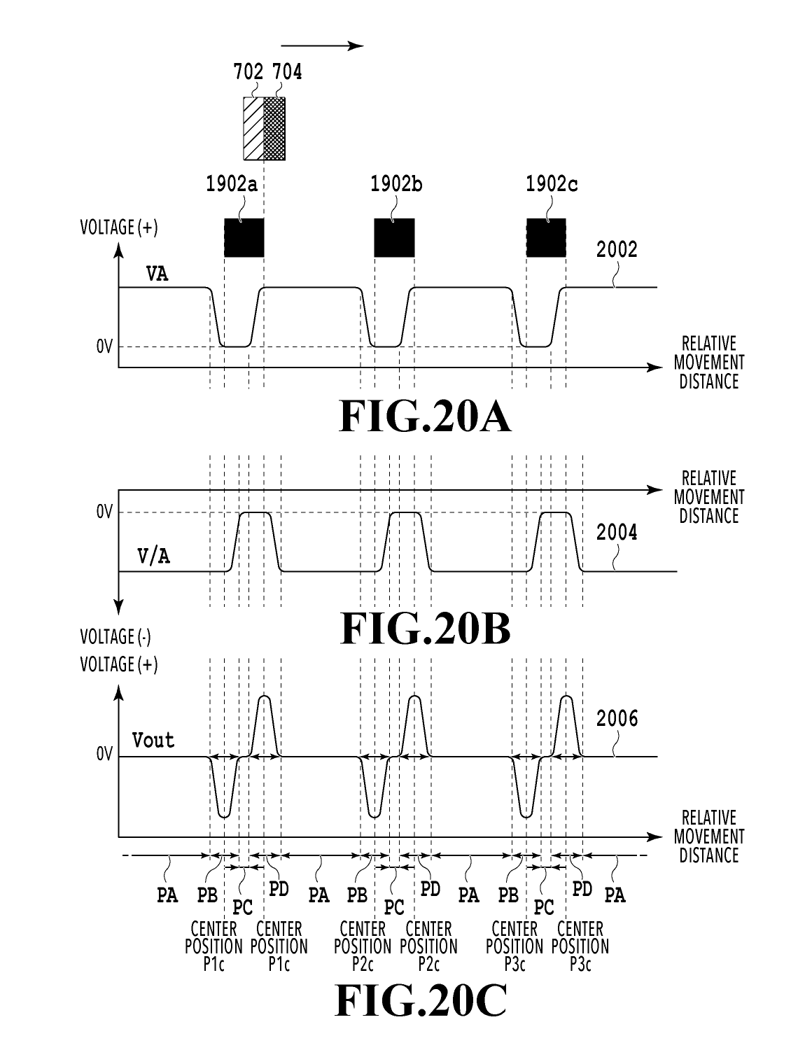

A description is given about the output voltage VA, output voltage V/A, and differential signal Vout in the detection circuit 900 at the time of detecting the position detection patches 1902. FIG. 20A to FIG. 20C are diagrams describing changes in output voltages from the two light-receiving parts and a change in differential signal from the differential amplifier at the time of detecting the position detection patches 1902. FIG. 20A illustrates an output waveform illustrating a change in output voltage VA from the first light-receiving part 702. FIG. 20B illustrates an output waveform illustrating a change in output voltage V/A from the second light-receiving part 704. FIG. 20C illustrates an output waveform illustrating a change in differential signal Vout. Note that, in FIG. 20A to FIG. 20C, the arrows above the light-receiving parts 702 and 704 indicate the movement direction of the print medium M relative to the first sensor 202.

First, a description is given about the change in output voltage VA. At the first sensor 202, the position detection patches 1902 enter the light-receiving region of the first light-receiving part 702, which is located on the downstream side in the movement direction (+X direction), and, as the proportion occupied by the position detection patches 1902 in the light-receiving region becomes larger, the amount of light received by the first light-receiving part 702 drops. In response to this drop in the amount of received light, the photocurrent Id decreases, and the output voltage VA from the I-V conversion circuit 904 drops from the positive peak value. Then, as the first sensor 202 moves further in the movement direction, at the time only the position detection patches 1902 are positioned in the light-receiving region of the first light-receiving part 702, the output voltage VA starts remaining at 0V.

Thereafter, due to the further movement of the first sensor 202 in the movement direction, the position detection patches 1902 move away from the light-receiving region of the first light-receiving part 702 and the blank region of the print medium M enters there, and, as the proportion of the blank region becomes larger in the light-receiving region, the amount of light received by the first light-receiving part 702 rises. As the photocurrent Id increases in accordance with this rise in the amount of received light and the output voltage VA rises, at the time only the blank region of the print medium M is located in the light-receiving region, the output voltage VA starts remaining at the positive peak value. Therefore, the change in output voltage VA at the time of detecting the position detection patches is as illustrated as the output waveform 2002 (see FIG. 20A).

Next, a description is given about the change in output voltage V/A. At the first sensor 202, the position detection patches 1902 enter the light-receiving region of the second light-receiving part 704, which is located on the upstream side in the movement direction, and, as the proportion occupied by the position detection patches 1902 in the light-receiving region becomes larger, the amount of light received by the second light-receiving part 704 drops. In response to this drop in the amount of received light, the photocurrent Id' decreases, and the output voltage V/A from the I-V conversion circuit 906 rises from the negative peak value. Then, as the first sensor 202 moves further in the movement direction, at the time only the position detection patches 1902 are positioned in the light-receiving region of the second light-receiving part 704, the output voltage V/A starts remaining at 0V.

Thereafter, due to the further movement of the first sensor 202 in the movement direction, the position detection patches 1902 move away from the light-receiving region of the second light-receiving part 704 and the blank region of the print medium M enters there, and, as the proportion occupied by the blank region in the light-receiving region becomes larger, the amount of light received by the second light-receiving part 704 rises. As the photocurrent Id' increases in accordance with this rise in the amount of received light and the output voltage V/A drops, at the time only the blank region of the print medium M is located in the light-receiving region, the output voltage V/A starts remaining at the negative peak value. Therefore, the change in output voltage V/A at the time of detecting the position detection patches is as illustrated as the output waveform 2004 (see FIG. 20B).

Next, a description is given about the change in differential signal Vout. At the time of detecting the position detection patches 1902, the output voltage VA drops from the positive peak value in accordance with the drop in the amount of light received by the first light-receiving part 702, and, after reaching 0V, its value rises in accordance with the rise in the amount of light received by the first light-receiving part 702 (see FIG. 20A). On the other hand, the output voltage V/A rises from the negative peak value in accordance with the drop in the amount of light received by the second light-receiving part 704, and, after reaching 0V, its value drops in accordance with the rise in the amount of light received by the second light-receiving part 704 (see FIG. 20B). Further, the differential signal Vout changes as illustrated in the output waveform 2006.

More specifically, at the time the position detection patches 1902 are not located in the light-receiving region of the first light-receiving part 702 and the light-receiving region of the second light-receiving part 704, that is, at the time only the blank region of the print medium M is located there, the first light-receiving part 702 and the second light-receiving part 704 receive a large amount of reflected light. Therefore, at this time, the output voltage VA is at the positive peak value and the output voltage V/A is at the negative peak value, and thus the differential signal Vout is at 0V (see the region PA in FIG. 20C).

As the first sensor 202 moves, at the time the position detection patches 1902 begin to enter the light-receiving region of the first light-receiving part 702, and the proportion occupied by the position detection patches 1902 in the light-receiving region is rising, the blank region of the print medium M is positioned in the light-receiving region of the second light-receiving part 704. Therefore, at this time, the output voltage VA drops from the positive peak value, the output voltage V/A remains at the negative peak value, and the differential signal Vout drops in accordance with the drop in the output voltage VA. Further, as the first sensor 202 further moves, at the time the position detection patches 1902 begin to enter the light-receiving region of the second light-receiving part 704, and the proportion occupied by the position detection patches in the light-receiving region is rising, only the position detection patches are positioned in the light-receiving region of the first light-receiving part 702. Therefore, at this time, the output voltage VA remains at 0V, the output voltage V/A rises from the negative peak value, and the differential signal Vout rises in accordance with the rise in the output voltage V/A. In this way, at the time of detecting one end portion of the position detection patches 1902, the change in differential signal Vout forms a downwardly-convex peak waveform (see the region PB in FIG. 20C).

Then, as the first sensor 202 moves, at the time only the position detection patches 1902 are located in the light-receiving region of the first light-receiving part 702 and only the position detection patches 1902 are located in the light-receiving region of the second light-receiving part 704, the output voltage VA and the output voltage V/A are at 0V. Therefore, the differential signal Vout is at 0V (see the region PC in FIG. 20C).

Further, as the first sensor 202 moves, at the time the position detection patches 1902 begin to move away from the light-receiving region of the first light-receiving part 702, and the proportion occupied by the blank region of the print medium M in the light-receiving region is rising, the position detection patches are positioned in the light-receiving region of the second light-receiving part 704. Therefore, at this time, the output voltage VA rises from 0V and the output voltage V/A remains at 0V, and thus the differential signal Vout rises, following the rise in the output voltage VA. Moreover, as the first sensor 202 further moves, at the time the position detection patches 1902 begin to move away from the light-receiving region of the second light-receiving part 704, and the proportion occupied by the blank region of the print medium M in the light-receiving region is rising, only the blank region is positioned in the light-receiving region of the first light-receiving part 702. Therefore, at this time, the output voltage VA remains at the positive peak value and the output voltage V/A drops from 0V, and thus the differential signal Vout drops in accordance with the drop in the output voltage V/A. In this way, at the time of detecting the other end portion of the position detection patches 1902, the change in differential signal Vout forms a upwardly-convex peak waveform (see the region PD in FIG. 20C).

### - Detection of the Position of the Position Detection Patterns

Next, a description is given about a method for detecting the position of the position detection patches 1902 based on the differential signal Vout. As at the time of detecting the position of the leading end of the print medium M, the center positions Pc of the respective widths of the downwardly-convex peak waveforms of the output waveform 2006 and the upwardly-convex peak waveforms of the output waveform 2006 are detected as the position information of both end portions of the respective position detection patches 1902 in the X direction. Then, the position information of the detected center positions Pc is stored in a storage area, such as the RAM 408, as the position information of both end portions of the respective position detection patches 1902. The length in the X direction of the position detection patches 1902 is set to be shorter than the interval between adjacent position detection patches, and thus the downwardly-convex peak waveform and the upwardly-convex peak waveform corresponding to one position detection patch 1902 can be determined based on that length.

Further, the method for detecting the center positions Pc of the upwardly-convex peak waveforms and the center positions Pc of the downwardly-convex peak waveforms is not limited to this. At the time of detecting the position detection patches, the number of light-receiving elements 300 forming the first light-receiving part 702 and the second light-receiving part 704 is selected according to the type of print medium M. Accordingly, the peak values of the differential signal Vout are greater (the differences from 0V are larger) than a predetermined value. Therefore, at the time of detecting the center positions Pc, a position where the value of differential signal Vout exceeds a preset threshold (a value whose difference from 0V is smaller than the predetermined value) and a position where it falls below the threshold are obtained, so as to detect the intermediate position between them as the center position.

After detecting the position detection patches 1902, while the print medium is conveyed by controlling the drive part 422 based on the position information of the detected position detection patches 1902, the second sensor 204 reads the registration adjustment pattern 1904, thereby executing registration adjustment.

### <Functional Effect>

As described above, in the present embodiment, the sensor that detects the widthwise end portions of the print medium includes two light-receiving parts that receive reflected light from the print medium M. Further, the number of light-receiving elements constituting each light-receiving part is changed depending on the type of print medium M based on the reflectivity of light, thereby making it possible to change the light-receiving region in each light-receiving part. As a result, in a case where the reflectivity of the print medium M is low, the amount of light received by each light-receiving part can be ensured by increasing the number of light-receiving elements that constitute each light-receiving part, making it possible to accurately detect the end portions of the print medium M.

Further, an end portion of the print medium M and an end portion of the position detection patches are detected based on changes in a differential signal generated by summing up and amplifying an output voltage from one light-receiving part and an output voltage from the other light-receiving part. Therefore, it is possible to detect the positions of these end portions without setting a threshold. Further, even if a threshold is set, by changing the light-receiving region depending on the type of print medium based on its reflectivity, the margin between a peak value and a threshold can be increased, thereby suppressing the effects of noise.

### (Second Embodiment)

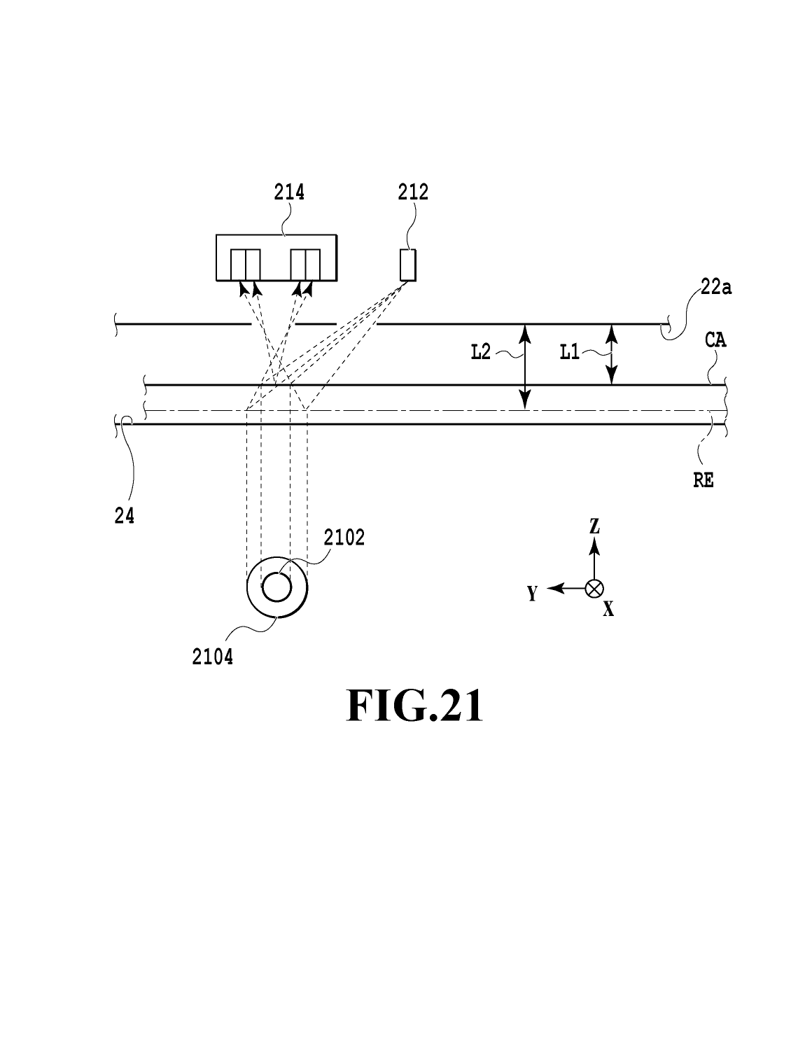

Next, with reference to FIG. 21 to FIG. 23, a description is given about a printing apparatus according to the second embodiment. In the following description, configurations that are the same or equivalent to those of the printing apparatus according to the above-described first embodiment are assigned with the same signs as those used in the above-described first embodiment, thereby omitting a detailed description thereof.

The second embodiment differs from the first embodiment described above in that the number of light-receiving elements constituting the two light-receiving parts in the first sensor 202 is changed depending on the distance between the print medium M and the carriage 22. The details are described below.

FIG. 21 is a diagram describing how a spot area formed on the print medium M by the light emitted from the light-emitting member 212 changes depending on the thickness of the print medium M. At the time the cardboard CA is used as the print medium M, the distance L1 between the bottom surface 22a of the carriage 22 facing the platen 24 and the print medium M is shorter than the distance L2 between the bottom surface 22a and the print medium M at the time the14 regular paper RE is used as the print medium M (see FIG. 21). In the present embodiment, regular paper is a print medium with a thickness of, for example, about 0.09 mm, and cardboard is a print medium that is thicker than regular paper beyond a predetermined range.

Accordingly, the spot area based on the light emitted from the light-emitting member 212 is larger on the regular paper RE, which is farther from the bottom surface 22a, than on the cardboard CA, which is closer from the bottom surface 22a. Therefore, the spot area 2102 based on the light emitted from the light-emitting member 212 on the cardboard CA, which is closer from the bottom surface 22a, is smaller than the spot area 2104 on the regular paper RE, which is farther from the bottom surface 22a.

Therefore, at the time the cardboard CA, on which the area of the spot area 2102 is relatively small, is used as the print medium M, the area in which reflected light is generated is smaller than at the time the regular paper RE, on which the area of the spot area 2104 is relatively large, is used as the print medium M. Therefore, if the cardboard CA is used as the print medium M, there is a possibility that the amount of light received by the two light-receiving parts of the light-receiving member 214 is less than at the time the regular paper RE is used as the print medium M.

Therefore, in the present embodiment, the number of light-receiving elements 300 in the two light-receiving parts is changed depending on the distance from the bottom surface 22a to the print medium M, i.e., the type of print medium M based on its thickness, which changes the size of the spot area. Specifically, the shorter the distance, the greater the number of light-receiving elements 300 in each of the two light-receiving parts, so that the reflected light is received by more light-receiving elements in each light-receiving part, thereby increasing the photocurrent generated by light reception at each light-receiving part.

### <Selection Patterns>

A description is given about the selection patterns associated with types of print medium M based on reflectivity in a case where the cardboard CA is used. As for the cardboard CA, there are also types of print media M based on reflectivity, and these types are classified into: glossy paper, which has the highest reflectivity of the printing surface to which ink is applied; plain paper, which has the second highest reflectivity after glossy paper; gray paper, which has the third highest reflectivity after plain paper; and others, which have the lowest reflectivity. Note that the selection patterns associated with the types of print medium M based on reflectivity in a case where the regular paper RE is used are the same as those in the first embodiment, and thus a description thereof is omitted.

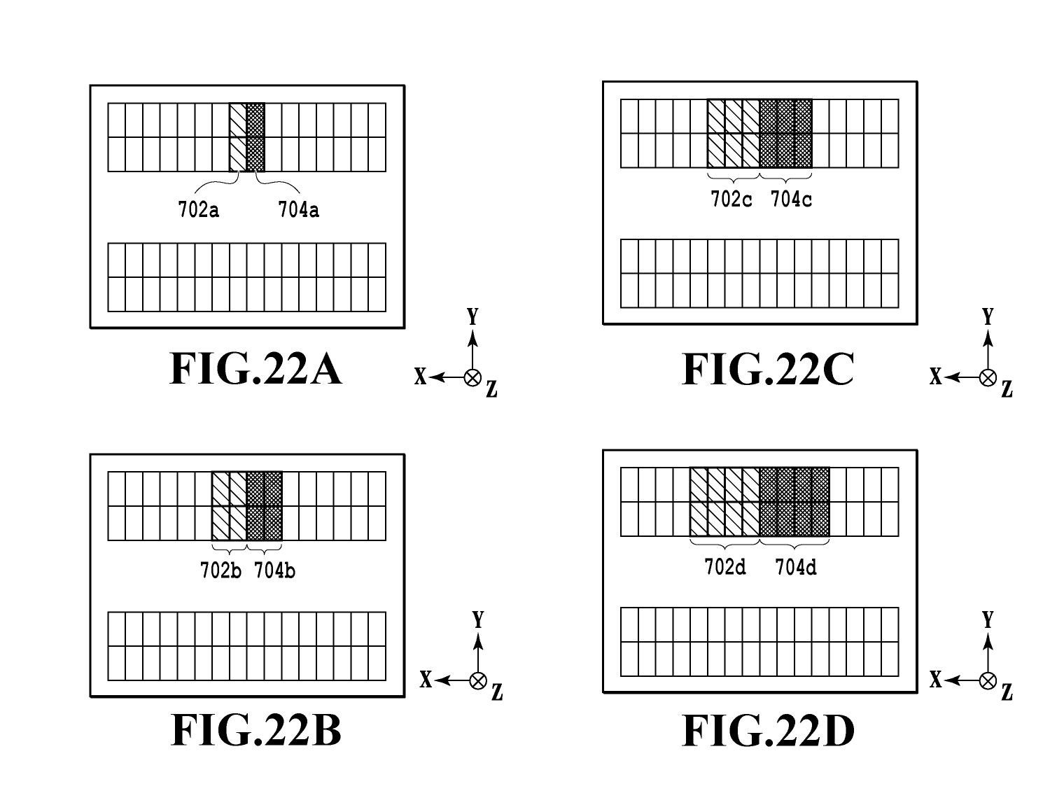

FIG. 22A to FIG. 22D are diagrams illustrating combinations of light-receiving elements 300 forming two light-receiving parts in each selection pattern that can be selected in a case where the cardboard CA is used. FIG. 22A illustrates Selection Pattern A, FIG. 22B illustrates Selection Pattern B, FIG. 22C illustrates Selection Pattern C, and FIG. 22D illustrates selection pattern D.

In Selection Pattern A that is selected in a case where the type of print medium M based on the reflectivity is glossy paper, four light-receiving elements 300 located adjacent to each other at the center of the PD array 302c and the PD array 302d in the X direction are selected, so that two elements serve as each light-receiving part. Specifically, in Selection Pattern A, two light-receiving elements, i.e., one light-receiving element located on the other side of the center position of the PD array 302c in the X direction and one light-receiving element located on the other side of the center position of the PD array 302d in the X direction, are selected as the first light-receiving part 702a. Further, two light-receiving elements, i.e., one light-receiving element located on one side of the center position of the PD array 302c in the X direction and one light-receiving element located on one side of the center position of the PD array 302d in the X direction, are selected as the second light-receiving part 704a (see FIG. 22A).

In Selection Pattern B that is selected in a case where the type of print medium M based on the reflectivity is plain paper, eight light-receiving elements 300 located adjacent to each other at the center of the PD array 302c and the PD array 302d in the X direction are selected, so that four elements serve as each light-receiving part. Specifically, in Selection Pattern B, four light-receiving elements, i.e., two light-receiving elements located on the other side of the center position of the PD array 302c in the X direction and two light-receiving elements located on the other side of the center position of the PD array 302d in the X direction, are selected as the first light-receiving part 702b. Further, four light-receiving elements, i.e., two light-receiving elements located on one side of the center position of the PD array 302c in the X direction and two light-receiving elements located on one side of the center position of the PD array 302d in the X direction, are selected as the second light-receiving part 704b (see FIG. 22B).

In Selection Pattern C that is selected in a case where the type of print medium M based on the reflectivity is gray paper, 12 light-receiving elements 300 located adjacent to each other at the center of the PD array 302c and the PD array 302d in the X direction are selected, so that six elements serve as each light-receiving part. Specifically, in Selection Pattern C, six light-receiving elements, i.e., three light-receiving elements located on the other side of the center position of the PD array 302c in the X direction and three light-receiving elements located on the other side of the center position of the PD array 302d in the X direction, are selected as the first light-receiving part 702b. Further, six light-receiving elements, i.e., three light-receiving elements located on one side of the center position of the PD array 302c in the X direction and three light-receiving elements located on one side of the center position of the PD array 302d in the X direction, are selected as the second light-receiving part 704b (see FIG. 22C).

In Selection Pattern D that is selected in a case where the type of print medium M based on the reflectivity is others, 16 light-receiving elements 300 located adjacent to each other at the center of the PD array 302c and the PD array 302d in the X direction are selected, so that eight elements serve as each light-receiving part. Specifically, in Selection Pattern D, eight light-receiving elements, i.e., four light-receiving elements located on the other side of the center position of the PD array 302c in the X direction and four light-receiving elements located on the other side of the center position of the PD array 302d in the X direction, are selected as the first light-receiving part 702b. Further, eight light-receiving elements, i.e., four light-receiving elements located on one side of the center position of the PD array 302c in the X direction and four light-receiving elements located on one side of the center position of the PD array 302d in the X direction, are selected as the second light-receiving part 704b (see FIG. 22D).

As described above, in Selection Patterns A to D, the number of light-receiving elements forming one light-receiving part is changed depending on the type of print medium M based on the reflectivity. More specifically, in Selection Patterns A to D, the number of light-receiving elements 300 forming one light-receiving part is set to increase for a type with lower reflectivity. Selection Patterns A to D described above are stored, for example, in a storage area such as the ROM 406 together with the above-described Selection Patterns 1 to 4.

The number of light-receiving elements 300 forming one light-receiving part in each of the above-described selection patterns is merely an example. In each selection pattern, the number of light-receiving elements 300 forming one light-receiving part may be any number as long as the number of light-receiving elements 300 is set to increase as the reflectivity of the print medium decreases. In a case of increasing the number of light-receiving elements 300, it is preferable to increase the number of light-receiving elements 300 along the movement direction of the first sensor 202 relative to the print medium, i.e., along the X direction, but it is also possible to increase the number of light-receiving elements 300 in the Y direction. Further, in each of the above-described selection patterns, light-receiving elements of the PD array 302c and the PD array 302d are selected as the light-receiving elements that form one light-receiving part; however, there is no such limitation. As the light-receiving elements forming one light-receiving part, the light-receiving elements 300 in any two of the four PD arrays, such as the PD array 302a and the PD array 302b, may be used. Alternatively, light-receiving elements 300 in three or more PD arrays may be used. Furthermore, in each of the selection patterns described above, the first light-receiving part 702 and the second light-receiving part 704 are formed with no interval; however, there is no such limitation. In each selection pattern, an interval of one or more light-receiving elements may be provided between the first light-receiving part 702 and the second light-receiving part 704.

### <Print Processing>

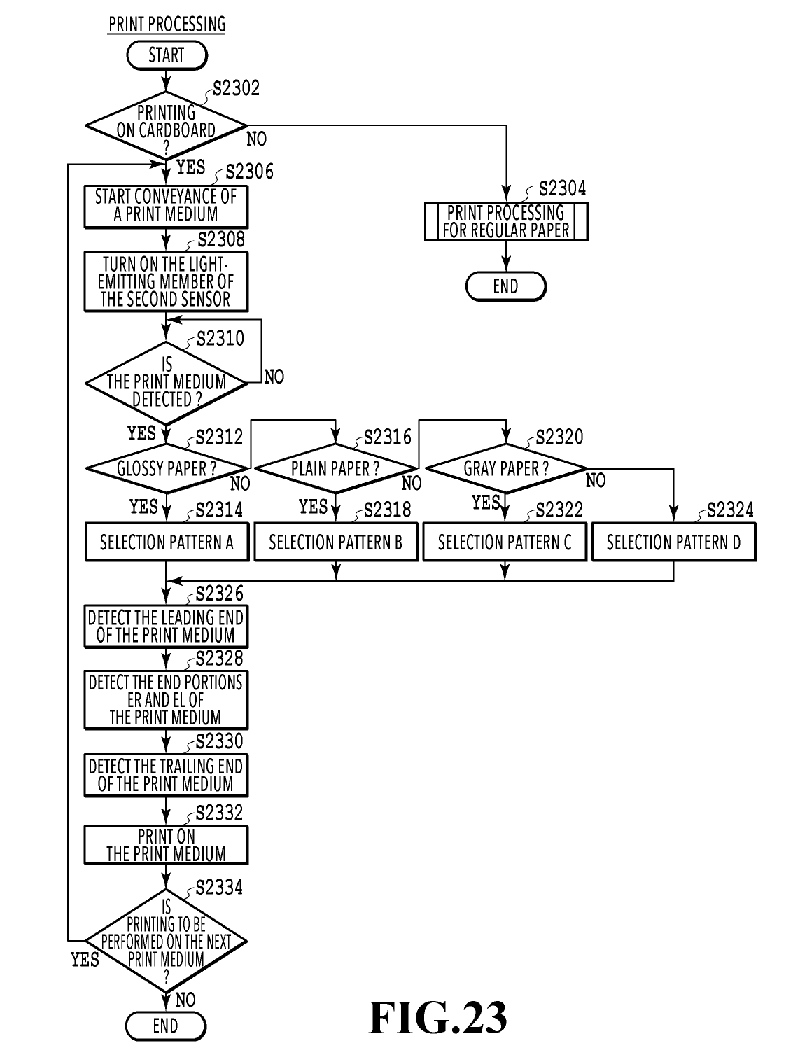

In the above-described configuration, the printing apparatus 10 executes print processing for performing printing on the print medium M based on an input job. FIG. 23 is a flowchart illustrating the details of processing of the print processing to be executed by the printing apparatus 10 according to the present embodiment. The series of processes illustrated in the flowchart of FIG. 23 is performed by the CPU 404 loading a program code stored in the ROM 406 into the RAM 408 and executing it. Alternatively, part or all of the functions in the steps of FIG. 23 may be executed by hardware such as an ASIC or an electronic circuit.

If the print processing is started, first, in S2302, the CPU 404 determines whether or not printing is to be performed on cardboard. Specifically, the information set in the job includes the print medium to be printed on, and in S2302, whether or not the print medium to be printed on is cardboard is determined based on the information about this set print medium. If it is determined in S2302 that the printing is not to be performed on cardboard, the processing proceeds to S2304, where the CPU 404 executes printing processing on regular paper, and ends this print processing. Note that the print processing on regular paper executed in S2304 is the same as the print processing described in the first embodiment, and thus a detailed description thereof is omitted.

If it is determined in S2302 that printing is to be performed on cardboard, the processing proceeds to S2306, where the CPU 404 feeds the print medium M from the tray 16 or the cassette, and starts conveying it to the printing part 14. Further, in S2308, the CPU 404 turns on the light-emitting member 222 of the second sensor 204. Then, in S2310, the CPU 404 determines whether or not the print medium M is detected by the second sensor 204. Note that since the specific details of processing of S2304 through S2310 described above are the same as those of S502 through S506 described above, the detailed explanations thereof are omitted.

If it is determined in S2310 that the print medium M is detected, the processing proceeds to S2312, where the CPU 404 determines whether or not the type of print medium M is glossy paper, based on the detection result of the second sensor 204. If it is determined in S2312 that the type of print medium M is glossy paper, the processing proceeds to S2314, where the CPU 404 selects Selection Pattern A as the selection pattern which is a combination of the light-receiving elements in the first light-receiving part 702 and the second light-receiving part 704, and then the processing proceeds to S2326 described later. Note that, although illustration in the drawings is omitted, a storage area such as the ROM 406 stores a table in which the types of print medium M and selection patterns are associated with the values of the data b1/b0. Specifically, in this table, glossy paper and Selection Pattern A are associated with "1/1" of the data b1/b0, and plain paper and Selection Pattern B are associated with "1/0" of the data b1/b0. Further, in this table, gray paper and Selection Pattern C are associated with "0/1" of the data b1/b0, and others and Selection Pattern D are associated with "0/0" of the data b1/b0.

Therefore, in S2312 and S2314, the determination is made based on the values of the data b1/b0 output from the determination circuit 600, with reference to this table. Therefore, in S2312, the CPU 404 determines whether or not the data b1/b0 output from the determination circuit 600 is "1/1". Then, if the data b1/b0 output from the determination circuit 600 is "1/1", the detected print medium M is determined as glossy paper. Further, in S2314, the CPU 404 selects Selection Pattern A associated with "1/1" of the data b1/b0 in the above-described table.

Further, if it is determined in S2312 that the type of print medium M is not glossy paper, the processing proceeds to S2316, where the CPU 404 determines whether or not the type of print medium M is plain paper. If it is determined in S2316 that the type of print medium M is plain paper, the processing proceeds to S2318, where the CPU 404 selects Selection Pattern B as the above-described selection pattern, and then the processing proceeds to S2326 described later. Therefore, in S2316, the CPU 404 determines whether or not the data b1/b0 output from the determination circuit 600 is "1/0". Then, if the data b1/b0 output from the determination circuit 600 is "1/0", it is determined as plain paper. Further, in S2318, the CPU 404 selects Selection Pattern B associated with "1/0" of the data b1/b0 in the above-described table.

Further, if it is determined in S2316 that the type of print medium M is not plain paper, the processing proceeds to S2320, where the CPU 404 determines whether or not the type of print medium M is gray paper. If it is determined in S2320 that the type of print medium M is gray paper, the processing proceeds to S2322, where the CPU 404 selects Selection Pattern C as the above-described selection pattern, and then the processing proceeds to S2326 described later. Therefore, in S2320, the CPU 404 determines whether or not the data b1/b0 output from the determination circuit 600 is "0/1". Then, if the data b1/b0 output from the determination circuit 600 is "0/1", it is determined as gray paper. Further, in S2322, the CPU 404 selects Selection Pattern C associated with "0/1" of the data b1/b0 in the above-described table.

Further, if it is determined in S2320 that the type of print medium M is not gray paper, the processing proceeds to S2324, where the CPU 404 selects Selection Pattern D as the above-described selection pattern, and then the processing proceeds to S2326 described later. That is, in S2324, the CPU 404 selects Selection Pattern D associated with "0/0" of the data b1/b0 in the above-described table.

Upon a determination of a selection pattern, in S2326, the CPU 404 detects the leading end of the print medium M. Next, in S2328, where the CPU 404 detects the widthwise (X-direction) end portions ER and EL of the print medium M. Thereafter, in S2330, the CPU 404 detects the trailing end of the print medium M. Then, in S2332, the CPU 404 performs printing on the print medium M. Upon completing the printing on the print medium M, in S2334, the CPU 404 determines whether or not to perform printing on the next print medium. If it is determined in S2334 that printing is to be performed on the next print medium, the processing returns to S2306. Further, if it is determined in S2334 that printing is not to be performed on the next print medium, this print processing ends. Note that since the specific details of processing of S2326 through S2334 described above are the same as those of S522 through S530 described above, the detailed explanations thereof are omitted.

### <Functional Effect>

As described above, in the present embodiment, the sensor that detects the widthwise end portions of the print medium includes two light-receiving parts that receive reflected light from the print medium M. Further, the number of light-receiving elements constituting each light-receiving part is changed depending on the type of print medium M based on the reflectivity of light, thereby making it possible to change the light-receiving region in each light-receiving part. Furthermore, the number of light-receiving elements constituting each light-receiving part is changed depending on the type of print medium M based on the thickness, thereby making it possible to change the light-receiving region in each light-receiving part. Accordingly, in the present embodiment, in addition to the functional effects of the first embodiment described above, even in a case where cardboard, on which the spot area of the light from a light-emitting member is small, is used as the print medium M, the amount of light received by each light-receiving element can be ensured, making it possible to accurately detect the end portions of the print medium M.

### (Other Embodiments)

Note that the above-described embodiments may be modified as shown in the following (1) through (8).

(1) Although not specifically described in the above embodiments, the two sensors on the carriage 22 may be arranged at any positions on the upstream side of the print head 20 in the conveyance direction (+Y direction) of the print medium M, and there are no limitation on the widthwise positions with respect to the print medium M. For example, it is also possible that one sensor is installed on one side of the carriage 22 in the X direction, and the other sensor is installed on the other side of the carriage 22 in the X direction.

(2) In the above-described embodiments, the light-receiving elements constituting the first light-receiving part 702 and the second light-receiving part 704 are determined based on a selection pattern selected according to the type of print medium M detected by the second sensor 204; however, there is no such limitation. For example, the above-described light-receiving elements may be determined according to the type of print medium M set by a printer driver or the like. In this case, if the set type of print medium M is glossy paper, Selection Pattern 1 is selected; if it is plain paper, Selection Pattern 2 is selected; if it is gray paper, Selection Pattern 3 is selected; and if it is others, Selection Pattern 4 is selected.

(3) In the above-described first embodiment, the movement directions of the first sensor 202 are different at the time of detecting the end portion ER and at the time of detecting the end portion EL; however, there is no such limitation. For example, the first sensor 202 may be configured to detect the positions of both the end portion ER and the end portion EL while moving in the +X direction or the −X direction. Further, in the above-described first embodiment, the first sensor 202 detects the end portions ER and EL at the time the first sensor 202 enters the print medium M; however, there is no such limitation. The first sensor 202 may be configured to detect the end portions ER and EL at the time of moving away from the print medium M. In this case, specifically, the end portion EL is detected while the first sensor 202 is moved in the +X direction, and the end portion ER is detected while the first sensor 202 is moved in the −X direction.

(4) In the above-described embodiments, in the detection circuit 900, the positive voltage value VA based on the light received by the first light-receiving part 702 and the negative voltage value V/A based on the light received by the second light-receiving part 704 are input to the differential amplifier 908; however, there is no such limitation. For example, it is also possible to input, to the differential amplifier 908, the positive voltage value VA based on the light received by the first light-receiving part 702 and the positive voltage value VA based on the light received by the second light-receiving part 704. Alternatively, it is also possible to input, to the differential amplifier 908, the negative voltage value V/A based on the light received by the first light-receiving part 702 and the negative voltage value V/A based on the light received by the second light-receiving part 704. In these cases, the differential amplifier 908 amplifies the difference between the two input voltage values and outputs the differential signal Vout. Furthermore, in these cases, in order to increase the width of the peak waveforms of an output waveform based on a change in differential signal Vout, it is preferable to provide an interval in the X direction between the light-receiving elements constituting the first light-receiving part 702 and the light-receiving elements constituting the second light-receiving part 704.

(5) In the above-described second embodiment, a description is given about the case in which the printing apparatus 10 executes printing on two types of print media M based on thickness, i.e., the cardboard CA and the regular paper RE; however, the print media M that can be printed on by the printing apparatus 10 are not limited to the two types mentioned above. The printing apparatus 10 may be configured to be capable of printing on three or more types of print media M based on thickness. In this case, selection patterns according to the type of print medium M based on reflectivity are set for each type based on thickness.

(6) In the above-described embodiments, the first sensor 202 includes the light-emitting member 212; however, there is no such limitation, and the light-emitting member 212 may be installed separately from the first sensor 202. Furthermore, in the above-described embodiment, the printing apparatus 10 is configured to perform printing on a print medium using a printing method that ejects ink to perform printing; however, there is no limitation as such, and various known technologies may be used as a printing method for a print medium.

(7) Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

(8) The above-described embodiments and various forms shown in (1) through (7) may be combined as appropriate.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

According to the present disclosure, it becomes possible to detect the position of a print medium with high accuracy regardless of the type of print medium.

This application claims the benefit of Japanese Patent Application No. 2024-193530, filed November 5, 2024, which is hereby incorporated by reference herein in its entirety.

What is claimed is:

1. A printing apparatus comprising:
a carriage with a print head mounted thereon that performs printing on a print medium, the carriage being configured to be movable in a width direction of the print medium, which intersects with a conveyance direction of the print medium;
a detection unit configured to detect the print medium by causing one or more light-receiving elements of a plurality of light-receiving elements installed on the carriage to function as a light-receiving part;
an obtaining unit configured to obtain information on a type of the print medium; and
a setting unit configured to set the light-receiving elements to function as the light-receiving part, based on the information obtained by the obtaining unit.

2. The printing apparatus according to claim 1,
wherein the obtaining unit obtains the information based on an amount of reflected light from the print medium among light irradiated onto the print medium.

3. The printing apparatus according to claim 1,
wherein the obtaining unit obtains the information that is input.

4. The printing apparatus according to claim 1,
wherein the detection unit includes two of the light-receiving parts, and obtains a change in a signal based on a sum or a difference of outputs from the two light-receiving parts at the time the print medium moves relative to the carriage.

5. The printing apparatus according to claim 1,
wherein the information is information on a type based on reflectivity of light of the print medium.

6. The printing apparatus according to claim 5,
wherein the setting unit sets the light-receiving elements to function as the light-receiving part such that the number of light-receiving elements to function as the light-receiving part for a first print medium is larger than the number of light-receiving elements to function as the light-receiving part for a second print medium which has higher reflectivity than the first print medium.

7. The printing apparatus according to claim 1,
wherein the information is information on a type based on thickness of the print medium.

8. The printing apparatus according to claim 7,
wherein the setting unit sets the light-receiving elements to function as the light-receiving part such that the number of light-receiving elements to function as the light-receiving part for a first print medium is larger than the number of light-receiving elements to function as the light-receiving part for a second print medium which has a smaller thickness than the first print medium.

9. The printing apparatus according to claim 4,
wherein the detection unit detects a position of the print medium based on a change in the signal at the time of moving relative to the print medium.

10. The printing apparatus according to claim 4,
wherein the detection unit detects a position of a patch printed on the print medium based on a change in the signal at the time of moving relative to the patch.

11. The printing apparatus according to claim 10 further comprising
a unit configured to read a pattern, which is printed other than the patch by the print head, with reference to the position of the patch.

12. The printing apparatus according to claim 4,
wherein, in a case of detecting an end portion of the print medium in the conveyance direction,
the setting unit sets the light-receiving elements such that two of the light-receiving parts are formed at different positions in the conveyance direction, and
the light-receiving elements to function as the two light-receiving parts are the same regardless of the information.

13. The printing apparatus according to claim 4,
wherein, at the time of detecting an end portion of the print medium in the width direction or a patch printed on the print medium, the setting unit
sets the light-receiving elements such that two of the light-receiving parts are formed at different positions in the width direction, and
makes the number of light-receiving elements to function as the light-receiving parts for a first print medium different in the width direction from the number of light-receiving elements to function as the light-receiving parts for a second print medium, based on the information.

14. The printing apparatus according to claim 1,
wherein the setting unit sets the light-receiving elements based on a plurality of patterns that have different numbers of light-receiving elements to function as the light-receiving part.

15. The printing apparatus according to claim 4,
wherein the detection unit obtains position information of a center position of a peak waveform in an output waveform indicating the change in the signal.

16. A control method of a printing apparatus including
a carriage with a print head mounted thereon that performs printing on a print medium, the carriage being configured to be movable in a width direction of the print medium, which intersects with a conveyance direction of the print medium, and
a detection unit configured to detect the print medium by causing one or more light-receiving elements of a plurality of light-receiving elements installed on the carriage to function as a light-receiving part,
the control method comprising:
an obtaining step for obtaining information on a type of the print medium; and
a setting step for setting the light-receiving elements to function as the light-receiving part, based on the information obtained in the obtaining step.
